(19) United States
(12) Patent Application Publication
(10) Pub. No.: US 2026/0052424 A1
(43) Pub. Date: Feb. 19, 2026

(54) METHOD AND APPARATUS FOR REPORTING DATA TRAFFIC BASED ON PREDICTION IN A WIRELESS COMMUNICATION SYSTEM

(71) Applicant: LG Electronics Inc., Seoul (KR)

(72) Inventors: Myoungsoo KIM, Seoul (KR); Sunghoon JUNG, Seoul (KR)

(21) Appl. No.: 19/103,468

(22) PCT Filed: Sep. 22, 2023
(86) PCT No.: PCT/KR2023/014470

§ 371 Date: Feb. 12, 2025

Related U.S. Application Data
(60) Provisional application No. 63/408,867, filed on Sep. 22, 2022.

(51) Int. Cl. H04W 28/02; H04W 24/06

(52) U.S. Cl. CPC H04W 28/0231; H04W 24/06

(57) ABSTRACT

A method and apparatus for reporting data traffic based on prediction in a wireless communication system is described. The method comprises: receiving, from a network, a configuration for a data traffic assistance information message, wherein the configuration includes a triggering condition for the data traffic assistance information message; deriving a predictive data traffic for a future time and/or a future location; based on the predictive data traffic satisfying the triggering condition, transmitting the data traffic assistance information message including (i) information on the predictive data traffic and (ii) information on the future time and/or the future location.

### TECHNICAL FIELD

The present disclosure relates to a method and apparatus for reporting data traffic based on prediction in a wireless communication system.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### DISCLOSURE OF INVENTION

### Technical Problem

The application of AI/ML to wireless communication has been studied to improve overall network and UE operation for performance and the ability to provide various services. Using AI/ML, both networks and UEs can predict mobility and share the results to improve performance.

From the point of view of network energy saving (NES), it aims to reduce the unnecessary resources not used from UEs according to the UE's assistance information. For example, if the amount of data traffic required from UEs is less, the network can activate a narrow bandwidth BWP only or de-configure the CG/SPS, if configured.

In some cases, the network can even tum off the network for power saving. However, wrong switch-off the cells or reducing resources can seriously deteriorate the UE performance. It can also affect neighbour cells by burdening them to serve the additional traffic. That is, wrong NES decision may make negative effect instead of an improvement.

To carefully decide the NES state, ML can be utilized to optimize the decision by collecting the predictive UE's assistance information on future traffic information. It can help to decide the start time of NES activation/deactivation and appropriate duration of each state. It can also help optimize the appropriate allocation of network resources reserved for each future time.

Future traffic information can be used by network to determine DRX parameters to better balance between packet transmission latency and UE power saving. Future traffic information can be also used to determine a suitable RRC state to balance among packet transmission latency, signalling overhead and UE power saving. Future traffic information, or it can be used to choose an optimal scheduling policy or scheduling resources. The information can be used by network to activate one or more serving cell or cell group configured in the UE for a certain time duration for power saving.

However, the if UE sends the future traffic information too frequently or report the future traffic information that are not meaningful, it places a signalling burden on both the UE and the network, Network may disable/turn-off the reporting of the future traffic just to avoid the signalling overhead, instead of exploiting the prediction capabilities of the UE.

Therefore, studies for reporting data traffic based on prediction in a wireless communication system are required.

### Solution to Problem

In an aspect, a method performed by a wireless device in a wireless communication system is provided. The method comprises: receiving, from a network, a configuration for a data traffic assistance information message, wherein the configuration includes a triggering condition for the data traffic assistance information message; deriving a predictive data traffic for a future time and/or a future location; based on the predictive data traffic satisfying the triggering condition, transmitting the data traffic assistance information message including (i) information on the predictive data traffic and (ii) information on the future time and/or the future location.

In another aspect, an apparatus for implementing the above method is provided.

### Advantageous Effects of Invention

The present disclosure can have various advantageous effects.

According to some embodiments of the present disclosure, a wireless device could efficiently report data traffic based on prediction in a wireless communication system.

For example, based on the prediction information received from the UE, the network can carefully decide the desirable NES state considering expected UE's data traffic conditions or desirable DRX configuration parameters to balance between delay and UE power saving. The present disclosure allows the network to avoid incorrect/inefficient switch-off of network or wrong radio resource reservation for the future time/location or inefficient DRX parameters to be configured to the UE.

For example, the network can determine the start time/duration of deactivation/activation of the network energy saving state through predictive data traffic information. Therefore, UE/Network performance impact due to wrong-switch off can be prevented.

For example, as a wireless device informs the network of the predictive data traffic, the network can use resources efficiently.

According to some embodiments of the present disclosure, a wireless network system could provide an efficient solution for activating or deactivating network energy solution by receiving the predictive data traffic report.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is

applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a Functional Framework for RAN Intelligence.

FIG. 11 shows an example of an AI/ML Model Training in OAM and AI/ML Model Inference in NG-RAN node.

FIG. 12 shows an example of Model Training and Model Inference both located in RAN node.

FIGS. 13 and 14 show an example of an architecture of neuron and neural network.

FIG. 15 shows an example of an AI/ML inference.

FIG. 16 shows an example of an MLP DNN model.

FIG. 17 shows an example of a CNN model.

FIG. 18 shows an example of an RNN model.

FIG. 19 shows an example of Reinforcement learning.

FIG. 20 shows an example of measurement reporting.

FIG. 21 shows an example of Model Training at OAM, Model Inference at NG-RAN.

FIG. 22 shows an example of Model Training and Model Inference at NG-RAN

FIG. 23 shows an example of a method for reporting data traffic based on prediction in a wireless communication system.

FIG. 24 shows an example of a method for reporting data traffic based on prediction in a wireless communication system.

FIG. 25 shows an example of a method for the predictive data traffic report performed by a base station (BS).

### MODE FOR THE INVENTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WIMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure. “A or B” may mean “only A”. “only B”, or “both A and B”. In other words, “A or B” in the present disclosure may be interpreted as “A and/or B”. For example. “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”. “only B”, or “both A and B”. For example, “A. B. C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”. “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

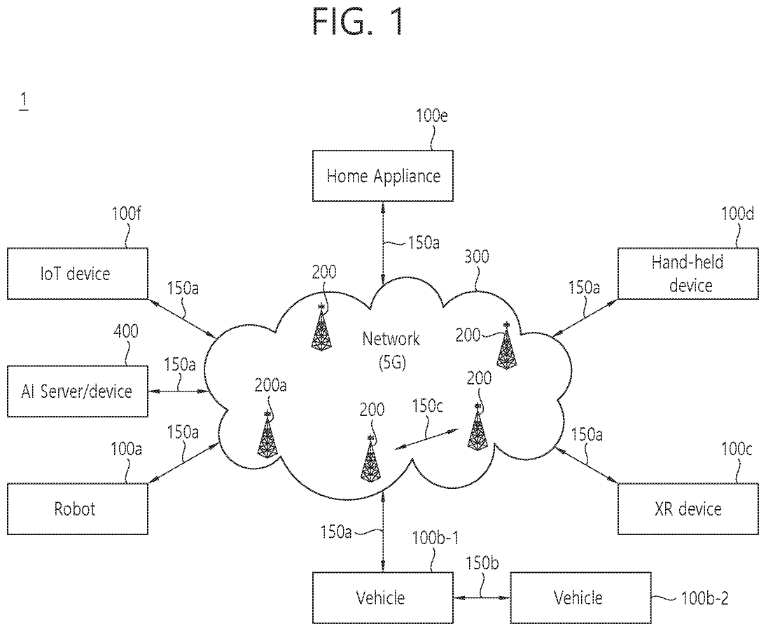

FIG. 1 shows an example of a communication system to which implementations of the

present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a. sidelink communication (or device-to-device (D2D) communication) 150b. inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example. LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example. ZigBee technology may generate personal area networks (PANs) associated with small/low-power digital communication based on various specifications such as IEEE 802.15.4 and may be called various names.

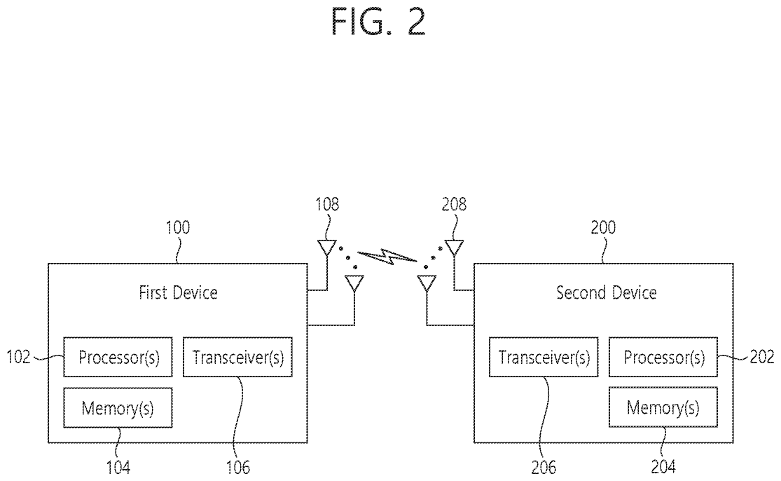

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) laver, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions. functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202, descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures. suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

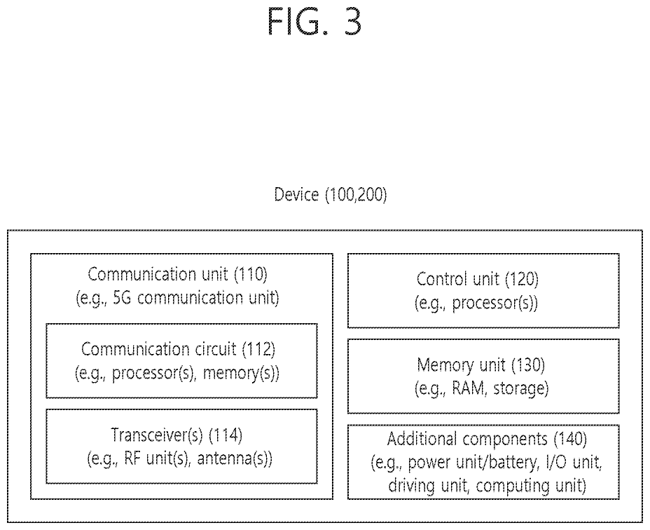

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

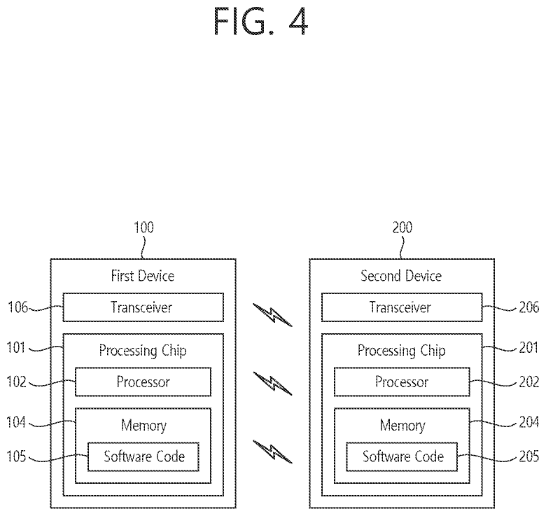

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102. perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory. such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

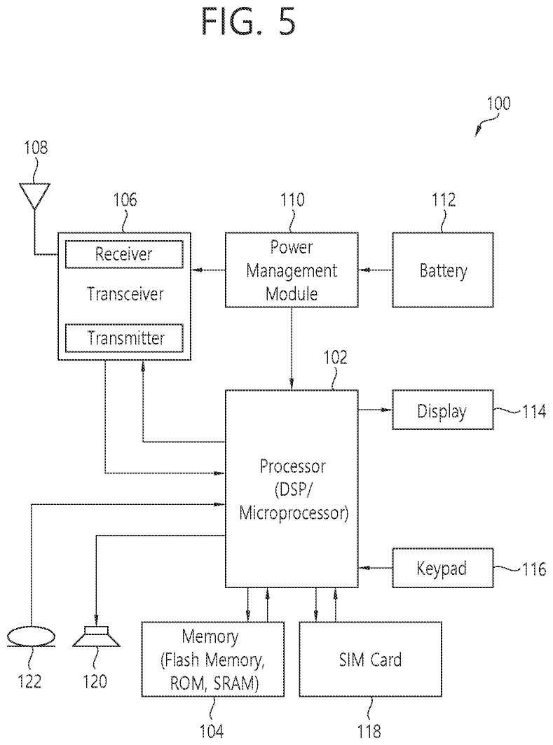

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset. logic circuit and/or data processing device. The processor 102 may be an application processor.

The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

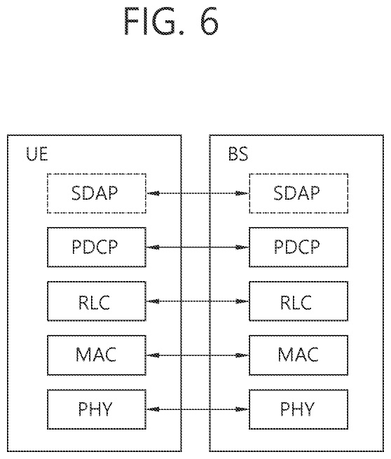

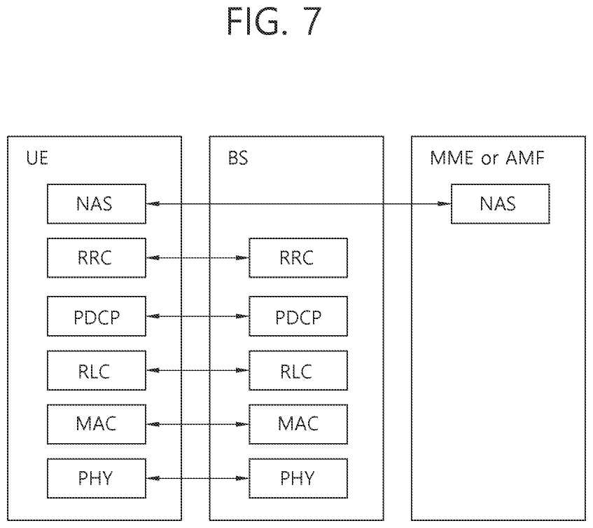

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into layer 1 (i.e., a PHY layer) and Layer 2. Referring to FIG. 7, the control plane protocol stack may be divided into Layer 1 (i.e., a PHY layer), Layer 2. Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels, scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH

The RLC sublayer supports three transmission modes: transparent mode (TM). unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection. PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data, reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management, establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

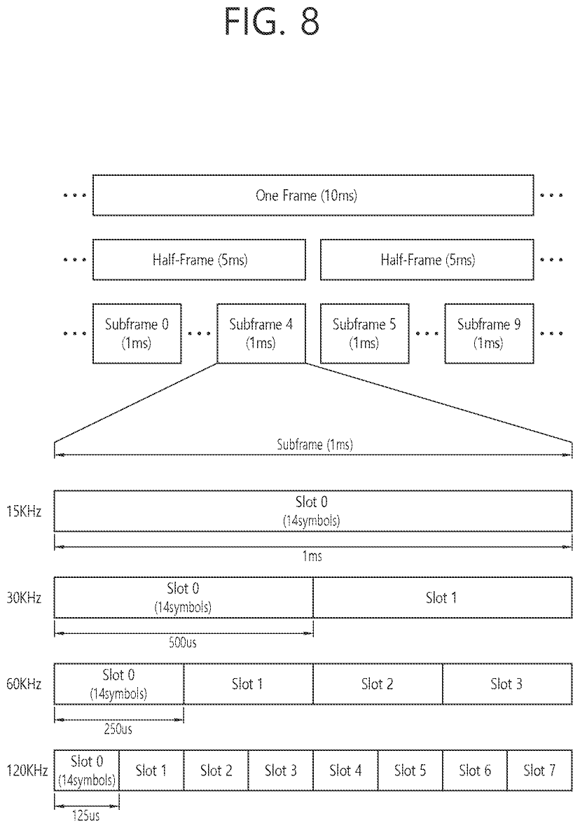

FIG. 8 shows a frame structure in a 3GPP based wireless communication system to which implementations of the present disclosure is applied.

The frame structure shown in FIG. 8 is purely exemplary and the number of subframes. the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2⁴*15 KHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 KHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 KHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{CRB}=N_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system. FR1 may mean “sub 6 GHz range”, FR2 may mean “above 6 GHz range,” and may be referred to as millimeter wave (mmW).

TABLE 3

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FRI may include an unlicensed band. Unlicensed bands may be used for a variety of purposes, for example for communication for vehicles (e.g., autonomous driving).

TABLE 4

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover. one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

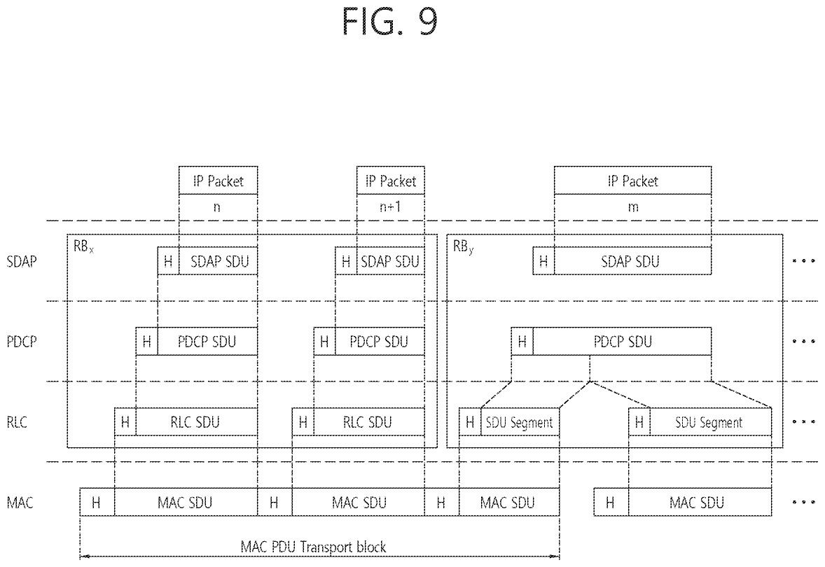

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to AI/ML are described

The application of AI/ML to wireless communications has been thus far limited to implementation-based approaches, both, at the network and the UE sides. A study on enhancement for data collection for NR and ENDC (FS_NR_ENDC_data_collect) has examined the functional framework for RAN intelligence enabled by further enhancement of data collection through use cases, examples etc, and identify the potential standardization impacts on current NG-RAN nodes and interfaces. In SA WG2 AI/ML related study, a network functionality NWDAF (Network Data Analytics Function) was introduced in Rel-15 and has been enhanced in Rel-16 and Rel-17.

In this study, we explore the benefits of augmenting the air-interface with features enabling improved support of AI/ML based algorithms for enhanced performance and/or reduced complexity/overhead Enhanced performance here depends on the use cases under consideration and could be, e.g., improved throughput, robustness, accuracy or reliability, etc.

Through studying a few carefully selected use cases, assessing their performance in comparison with traditional methods and the associated potential specification impacts that enable their solutions, this SI will lay the foundation for future air-interface use cases leveraging AI/ML techniques.

The goal is that sufficient use cases will be considered to enable the identification of a common AI/ML framework, including functional requirements of AI/ML architecture, which could be used in subsequent projects. The study should also identify areas where AI/ML could improve the performance of air-interface functions.

The study will serve identifying what is required for an adequate AI/ML model characterization and description establishing pertinent notation for discussions and subsequent evaluations. Various levels of collaboration between the gNB and UE are identified and considered.

Evaluations to exercise the attainable gains of AI/ML based techniques for the use cases under consideration will be carried out with the corresponding identification of KPIs with the goal to have a better understanding of the attainable gains and associated complexity requirements.

Finally, specification impact will be assessed in order to improve the overall understanding of what would be required to enable AI/ML techniques for the air-interface.

For the study on AI/ML for air-interface, the basic framework and principles agreed for FS NR ENDC data collect should be taken into consideration for possible applicability.

Study the 3GPP framework for AI/ML for air-interface corresponding to each target use case regarding aspects such as performance, complexity, and potential specification impact.

Use cases to focus on:

1> Initial set of use cases includes:

a) CSI feedback enhancement, e.g., overhead reduction, improved accuracy, prediction [RAN1]

b) Beam management, e.g., beam prediction in time, and/or spatial domain for overhead and latency reduction, beam selection accuracy improvement [RAN1]

c) Positioning accuracy enhancements for different scenarios including, e.g., those with heavy NLOS conditions [RAN1]

2> Finalize representative sub use cases for each use case for characterization and baseline performance evaluations

a) The AI/ML approaches for the selected sub use cases need to be diverse enough to support various requirements on the gNB-UE collaboration levels
the selection of use cases for this study solely targets the formulation of a framework to apply AI/ML to the air-interface for these and other use cases. The selection itself does not intend to provide any indication of the prospects of any future normative project.

AV/ML model, terminology and description to identify common and specific characteristics for framework investigations:

3> Characterize the defining stages of AI/ML related algorithms and associated complexity:

a) Model generation, e.g., model training (including input/output, pre-/post-process, online/offline as applicable), model validation, model testing, as applicable

b) Inference operation, e.g., input/output, pre-/post-process, as applicable

4> Identify various levels of collaboration between UE and gNB pertinent to the selected use cases, e.g.,

a) No collaboration: implementation-based only AI/ML algorithms without information exchange [for comparison purposes]

b) Various levels of UE/gNB collaboration targeting at separate or joint ML operation.

5> Characterize lifecycle management of AI/ML model: e.g., model training, model deployment, model inference, model monitoring, model updating

6> Dataset(s) for training, validation, testing, and inference

7> Identify common notation and terminology for AI/ML related functions,

procedures and interfaces

8> Note: Consider the work done for FS_NR_ENDC_data_collect when appropriate

For the use cases under consideration:
Evaluate performance benefits of AI/ML based algorithms for the agreed use cases in the final representative set:

a) Methodology based on statistical models, for link and system level simulations.

i. Extensions of 3GPP evaluation methodology for better suitability to AI/ML based techniques should be considered as needed.

ii. Whether field data are optionally needed to further assess the performance and robustness in real-world environments should be discussed as part of the study.

iii. Need for common assumptions in dataset construction for training, validation and test for the selected use cases.

iv. Consider adequate model training strategy, collaboration levels and associated implications

v. Consider agreed-upon base AI model(s) for calibration

vi. AI model description and training methodology used for evaluation should be reported for information and cross-checking purposes

b) KPIs: Determine the common KPIs and corresponding requirements for the AI/ML operations. Determine the use-case specific KPIs and benchmarks of the selected use-cases.

i. Performance, inference latency and computational complexity of AI/ML based algorithms should be compared to that of a state-of-the-art baseline

ii. Overhead, power consumption (including computational), memory storage, and hardware requirements (including for given processing delays) associated with enabling respective AI/ML scheme, as well as generalization capability should be considered.
Assess potential specification impact, specifically for the agreed use cases in the final representative set and for a common framework:

c) PHY layer aspects, e.g., (RAN1)

i. Consider aspects related to, e.g., the potential specification of the AI Model lifecycle management, and dataset construction for training, validation and test for the selected use cases

ii. Use case and collaboration level specific specification impact, such as new signalling, means for training and validation data assistance, assistance information, measurement, and feedback

d) Protocol aspects, e.g., (RAN2)-RAN2 only starts the work after there is sufficient progress on the use case study in RAN1

i. Consider aspects related to, e.g., capability indication, configuration and control procedures (training/inference), and management of data and AI/ML model, per RAN1 input

ii. Collaboration level specific specification impact per use case

e) Interoperability and testability aspects, e.g., (RAN4)-RAN4 only starts the work after there is sufficient progress on use case study in RAN1 and RAN2

i. Requirements and testing frameworks to validate AI/ML based performance enhancements and ensuring that UE and gNB with AI/ML meet or exceed the existing minimum requirements if applicable

ii. Consider the need and implications for AI/ML processing capabilities definition
specific AI/ML models are not expected to be specified and are left to implementation. User data privacy needs to be preserved.
The study on AI/ML for air interface is based on the current RAN architecture and new interfaces shall not be introduced.

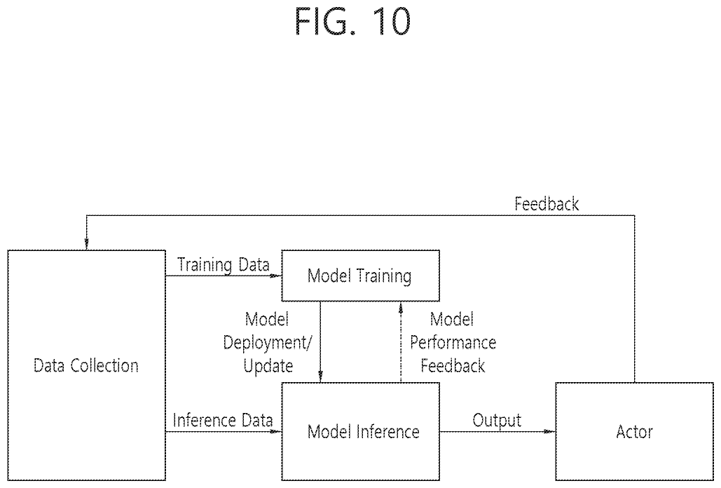

FIG. 10 shows an example of a Functional Framework for RAN Intelligence.
Data Collection is a function that provides input data to Model training and Model inference functions. AI/ML algorithm specific data preparation (e.g., data pre-processing and cleaning, formatting, and transformation) is not carried out in the Data Collection function.

Examples of input data may include measurements from Ues or different network entities, feedback from Actor, output from an AI/ML model.
Training Data: Data needed as input for the AI/ML Model Training function.
Inference Data: Data needed as input for the AI/ML Model Inference function.
Model Training is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required.
   Model Deployment/Update: Used to initially deploy a trained, validated, and tested AI/ML model to the Model Inference function or to deliver an updated model to the Model Inference function.
Model Inference is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required.
   Output: The inference output of the AI/ML model produced by a Model Inference function.
      Note: Details of inference output are use case specific.
   Model Performance Feedback: It may be used for monitoring the performance of the AI/ML model, when available.
Actor is a function that receives the output from the Model Inference function and triggers or performs corresponding actions. The Actor may trigger actions directed to other entities or to itself.
   Feedback: Information that may be needed to derive training data, inference data or to monitor the performance of the AI/ML Model and its impact to the network through updating of KPIs and performance counters.

Hereinafter, technical features related to Mobility Optimization are described.

Mobility management is the scheme to guarantee the service-continuity during the mobility by minimizing the call drops, RLFs, unnecessary handovers, and ping-pong. For the future high-frequency network, as the coverage of a single node decreases, the frequency for UE to handover between nodes becomes high, especially for high-mobility UE. In addition, for the applications characterized with the stringent QoS requirements such as reliability, latency etc., the QoE is sensitive to the handover performance, so that mobility management should avoid unsuccessful handover and reduce the latency during handover procedure. However, for the conventional method, it is challengeable for trial-and-error-based scheme to achieve nearly zero-failure handover. The unsuccessful handover cases are the main reason for packet dropping or extra delay during the mobility period, which is unexpected for the packet-drop-intolerant and low-latency applications. In addition, the effectiveness of adjustment based on feedback may be weak due to randomness and inconstancy of transmission environment. Besides the baseline case of mobility, areas of optimization for mobility include dual connectivity, CHO, and DAPS, which each has additional aspects to handle in the optimization of mobility.

Mobility aspects of SON that can be enhanced by the use of AI/ML include
Reduction of the probability of unintended events
UE Location/Mobility/Performance prediction
Traffic Steering

### Reduction of the Probability of Unintended Events Associated With Mobility

Examples of such unintended events are:
Intra-system Too Late Handover: A radio link failure (RLF) occurs after the UE has stayed for a long period of time in the cell; the UE attempts to re-establish the radio link connection in a different cell.
Intra-system Too Early Handover: An RLF occurs shortly after a successful handover from a source cell to a target cell or a handover failure occurs during the handover procedure; the UE attempts to re-establish the radio link connection in the source cell.
Intra-system Handover to Wrong Cell: An RLF occurs shortly after a successful handover from a source cell to a target cell or a handover failure occurs during the handover procedure; the UE attempts to re-establish the radio link connection in a cell other than the source cell and the target cell.
Successful Handover: During a successful handover, there is underlying issue.

RAN Intelligence could observe multiple HO events with associated parameters, use this information to train its ML model and try to identify sets of parameters that lead to successful Hos and sets of parameters that lead to unintended events.

### UE Location/Mobility/Performance Prediction

Predicting UE's location is a key part for mobility optimisation, as many RRM actions related to mobility (e.g., selecting handover target cells) can benefit from the predicted UE location/trajectory. UE mobility prediction is also one key factor in the optimization of early data forwarding particularly for CHO. UE Performance prediction when the UE is served by certain cells is a key factor in determining which is the best mobility target for maximisation of efficiency and performance.

### Traffic Steering

Efficient resource handling can be achieved adjusting handover trigger points and selecting optimal combination of Pcell/PSCell/Scells to serve a user.

Existing traffic steering can also be improved by providing a RAN node with information related to mobility or dual connectivity.

For example, before initiating a handover, the source gNB could use feedbacks on UE performance collected for successful handovers occurred in the past and received from neighbouring gNBs.

Similarly, for the case of dual connectivity, before triggering the addition of a secondary gNB or triggering SN change, an eNB could use information (feedbacks) received in the past from the gNB for successfully completed SN Addition or SN Change procedures.

In the two reported examples, the source RAN node of a mobility event, or the RAN node acting as Master Node (a eNB for EN-DC, a gNB for NR-DC) can use feedbacks received from the other RAN node, as input to an AI/ML function supporting traffic related decisions (e.g., selection of target cell in case of mobility, selection of a PSCell/Scell(s) in the other case), so that future decisions can be optimized.

### Locations for AI/ML Model Training and AI/ML Model Inference

Considering the locations of AI/ML Model Training and AI/ML Model Inference for mobility solution, the following two options are considered:
The AI/ML Model Training function is deployed in OAM, while the Model Inference function resides within the RAN node
Both the AI/ML Model Training function and the AI/ML Model Inference function reside within the RAN node

Furthermore, for CU-DU split scenario, following option is possible:
AI/ML Model Training is located in CU-CP or OAM, and AI/ML Model Inference function is located in CU-CP

gNB is also allowed to continue model training based on AI/ML model trained in the OAM.

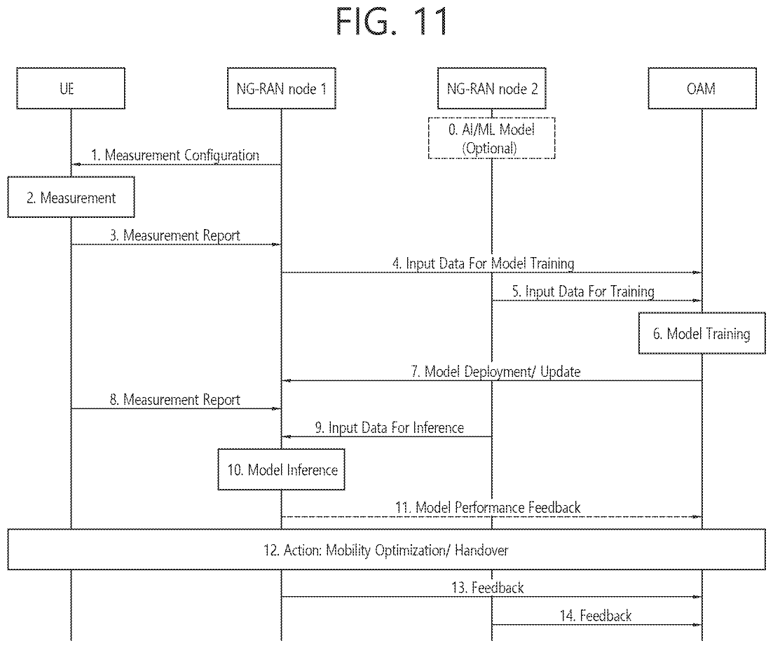

FIG. 11 shows an example of an AI/ML Model Training in OAM and AI/ML Model Inference in NG-RAN node

Step 0. NG-RAN node 2 is assumed to optionally have an AI/ML model, which can generate required input such as resource status and utilization prediction/estimation etc.

Step 1. The NG-RAN node configures the measurement information on the UE side and sends configuration message to UE including configuration information.

Step 2. The UE collects the indicated measurement, e.g., UE measurements related to RSRP, RSRQ. SINR of serving cell and neighbouring cells.

Step 3. The UE sends measurement report message to NG-RAN node 1 including the

required measurement.

Step 4. The NG-RAN node 1 sends the input data for training to OAM, where the input data for training includes the required input information from the NG-RAN node 1 and the measurement from UE.

Step 5. The NG-RAN node 2 sends the input data for training to OAM, where the input data for training includes the required input information from the NG-RAN node 2. If the NG-RAN node 2 executes the AI/ML model, the input data for training can include the corresponding inference result from the NG-RAN node 2.

Step 6. Model Training. Required measurements are leveraged to training AI/ML model for UE mobility optimization.

Step 7. OAM sends AI/ML Model Deployment Message to deploy the trained/updated AI/ML model into the NG-RAN node(s). The NG-RAN node can also continue model training based on the received AI/ML model from OAM.

Note: This step is out of RAN3 Rel-17 scope.

Step 8. The NG-RAN node 1 obtains the measurement report as inference data for UE mobility optimization.

Step 9. The NG-RAN node 1 obtains the input data for inference from the NG-RAN node 2 for UE mobility optimization, where the input data for inference includes the required input information from the NG-RAN node 2. If the NG-RAN node 2 executes the AI/ML model, the input data for inference can include the corresponding inference result from the NG-RAN node 2.

Step 10. Model Inference. Required measurements are leveraged into Model Inference to output the prediction, e.g., UE trajectory prediction, target cell prediction, target NG-RAN node prediction, etc.

Step 11. The NG-RAN 1 sends the model performance feedback to OAM if applicable. Note: This step is out of RAN3 scope.

Step 12: According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node.

Step 13. The NG-RAN node 1 sends the feedback information to OAM.

Step 14. The NG-RAN node 2 sends the feedback information to OAM.

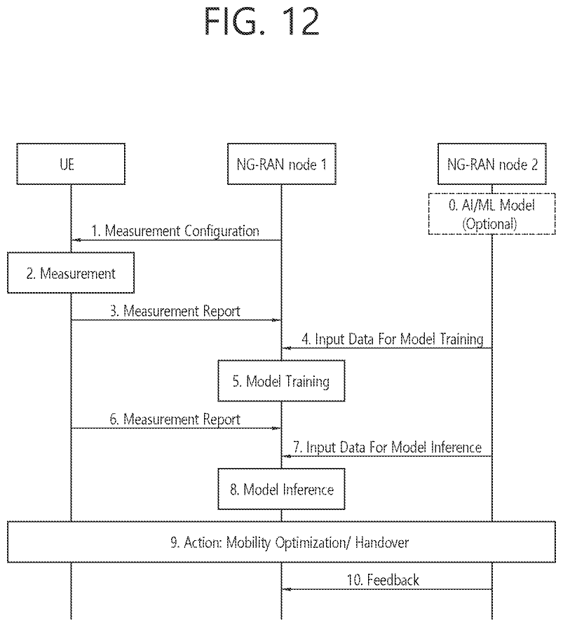

FIG. 12 shows an example of Model Training and Model Inference both located in RAN node.

Step 0. NG-RAN node 2 is assumed to optionally have an AI/ML model, which can generate required input such as resource status and utilization prediction/estimation etc.

Step 1. NG-RAN node1 configures the measurement information on the UE side and sends configuration message to UE including configuration information.

Step 2. UE collects the indicated measurement, e.g., UE measurements related to RSRP. RSRQ, SINR of serving cell and neighbouring cells.

Step 3. UE sends measurement report message to NG-RAN node1 including the required measurement.

Step 4. The NG-RAN node 1 obtains the input data for training from the NG-RAN node2, where the input data for training includes the required input information from the NG-RAN node 2. If the NG-RAN node 2 executes the AI/ML model, the input data for training can include the corresponding inference result from the NG-RAN node 2.

Step 5. Model training. Required measurements are leveraged to training AI/ML model for mobility optimization.

Step 6. NG-RAN node1 obtains the measurement report as inference data for real-time UE mobility optimization.

Step 7. The NG-RAN node 1 obtains the input data for inference from the NG-RAN node 2 for UE mobility optimization, where the input data for inference includes the required input information from the NG-RAN node 2. If the NG-RAN node 2 executes the AI/ML model, the input data for inference can include the corresponding inference result from the NG-RAN node 2.

Step 8. Model Inference. Required measurements are leveraged into Model Inference to output the prediction, including e.g., UE trajectory prediction, target cell prediction, target NG-RAN node prediction, etc.

Step 9: According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node.

Step 10. The NG-RAN node 2 sends feedback information after mobility optimization action to the NG-RAN node 1.

For example, UE mobility information for training purposes is only sent to gNBs that requested such information or when triggered.

### Input of AI/ML-Based Mobility Optimization

The following data is required as input data for mobility optimization.

From the UE:
UE location information (e.g., coordinates, serving cell ID, moving velocity) interpreted by gNB implementation when available.
Radio measurements related to serving cell and neighbouring cells associated with UE location information, e.g., RSRP, RSRQ, SINR.
UE Mobility History Information.

From the neighbouring RAN nodes:
UE's history information from neighbour
Position, QoS parameters and the performance information of historical HO-ed UE (e.g., loss rate, delay, etc.)
Current/predicted resource status
UE handovers in the past that were successful and unsuccessful, including too-early, too-late, or handover to wrong (sub-optimal) cell, based on existing SON/RLF report mechanism.

From the local node:
UE trajectory prediction
Current/predicted resource status
Current/predicted UE traffic

### Output of AI/ML-Based Mobility Optimization

AI/ML-based mobility optimization can generate following information as output:
UE trajectory prediction (Latitude, longitude, altitude, cell ID of UE over a future period of time)

Note: Whether the UE trajectory prediction is an external output to the node hosting the Model Inference function should be discussed during the normative work phase.
Estimated arrival probability in CHO and relevant confidence interval
Predicted handover target node, candidate cells in CHO, may together with the confidence of the predication
Priority, handover execution timing, predicted resource reservation time window for CHO.
UE traffic prediction (will be used by the RAN node internally and the details are left to normative work phase)
Model output validity time will be discussed during R18 normative work per inference output.

### Feedback of AI/ML-Based Mobility Optimization

The following data is required as feedback data for mobility optimization.
QoS parameters such as throughput, packet delay of the handed-over UE, etc.
Resource status information updates from target NG-RAN.
Performance information from target NG-RAN. The details of performance information are to be discussed during normative work phase.

### Standard Impact

To improve the mobility decisions at a gNB (gNB-CU), a gNB can request mobility feedback from a neighbouring node. Details of the procedure will be determined during the normative phase.

If existing UE measurements are needed by a gNB for AI/ML-based mobility optimization, RAN3 shall reuse the existing framework (including MDT and RRM measurements). Whether new UE measurements are needed is left to normative phase based on the use case description.

MDT procedure enhancements should be discussed during the normative phase.

### Potential Xn Interface Impact

Predicted resource status info and performance info from candidate target NG-

RAN node to source NG-RAN node
New signaling procedure or existing procedure to retrieve input information via Xn interface.
New signaling procedure or existing procedure to retrieve feedback information via Xn interface.

Hereinafter, technical features related to AI and ML are described.

Artificial Intelligence (AI)/Machine Learning (ML) is being used in a range of application domains across industry sectors, realizing significant productivity gains. In particular, in mobile communications systems, mobile devices (e.g. smartphones, smart vehicles, UAVs, mobile robots) are increasingly replacing conventional algorithms (e.g. speech recognition, machine translation, image recognition, video processing, user behaviour prediction) with AI/ML models to enable applications like enhanced photography, intelligent personal assistants. VR/AR, video gaming, video analytics, personalized shopping recommendation, autonomous driving/navigation, smart home appliances, mobile robotics, mobile medicals, as well as mobile finance.

Artificial Intelligence (AI) is the science and engineering to build intelligent machines capable of carrying out tasks as humans do.

### Deep Neural Network

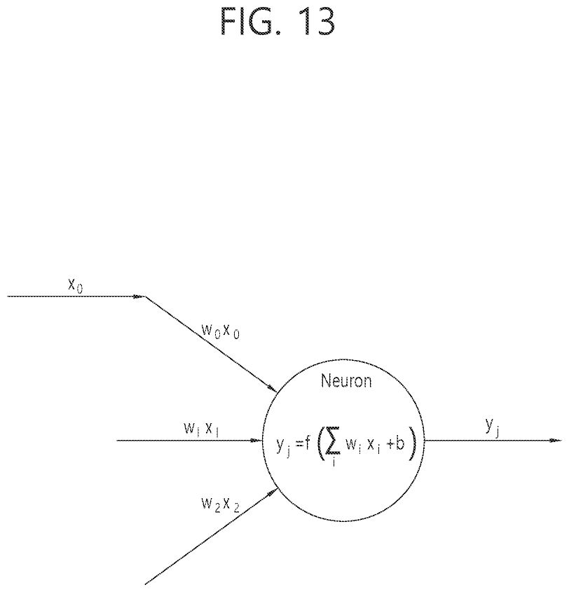

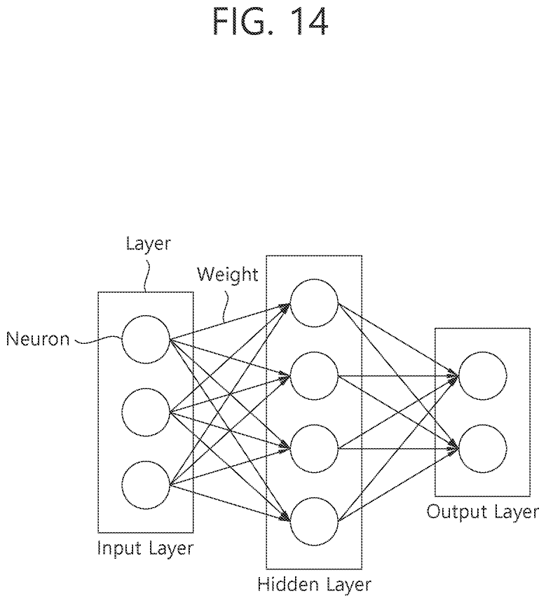

FIGS. 13 and 14 show an example of an architecture of neuron and neural network.

Within the ML field, there is an area that is often referred to as brain-inspired computation, which is a program aiming to emulate some aspects of how we understand the brain to operate. Since it is believed that the main computational elements a human brain are 86 billion neurons, the two subareas of brain-inspired computation are both inspired by the architecture of a neuron, as shown in FIG. 13.

Compared to spiking computing approaches, the more popular ML approaches are using “neural network” as the model. Neural networks (NN) take their inspiration from the notion that a neuron's computation involves a weighted sum of the input values. But instead of simply outputting the weighted sum, a NN applies a nonlinear function to generate an output only if the inputs cross some threshold, as shown in FIG. 13.

FIG. 14 shows a diagrammatic picture of a computational neural network. The neurons in the input layer receive some values and propagate them to the neurons in the middle layer of the network, which is also called a “hidden layer”. The weighted sums from one or more hidden layers are ultimately propagated to the output layer, which presents the final outputs of the network.

Neural networks having more than three layers, i.e., more than one hidden layer are called deep neural networks (DNN). In contrast to the conventional shallow-structured NN architectures, DNNs, also referred to as deep learning, made amazing breakthroughs since 2010s in many essential application areas because they can achieve human-level accuracy or even exceed human accuracy. Deep learning techniques use supervised and/or unsupervised strategies to automatically learn hierarchical representations in deep architectures for classification. With a large number of hidden layers, the superior performance of DNNs comes from its ability to extract high-level features from raw sensory data after using statistical learning over a large amount of data to obtain an effective representation of an input space. In recent years, thanks to the big data obtained from the real world, the rapidly increased computation capacity and continuously-evolved algorithms. DNNs have become the most popular ML models for many AI applications.

### Training and Inference

Training is a process in which a AI/ML model learns to perform its given tasks, more specifically, by optimizing the value of the weights in the DNN. A DNN is trained by inputting a training set, which are often correctly-labelled training samples. Taking image classification for instance, the training set includes correctly-classified images. When training a network, the weights are usually updated using a hill-climbing optimization process called gradient descent. The gradient indicates how the weights should change in order to reduce the loss (the gap between the correct outputs and the outputs computed by the DNN based on its current weights). The training process is repeated iteratively to continuously reduce the overall loss. Until the loss is below a predefined threshold, the DNN with high precision is obtained.

There are multiple ways to train the network for different targets. The introduced above is supervised learning which uses the labelled training samples to find the correct outputs for a task. Unsupervised learning uses the unlabelled training samples to find the structure or clusters in the data. Reinforcement learning can be used to output what action the agent should take next to maximize expected rewards. Transfer learning is to adjust the previously-trained weights (e.g. weights in a global model) using a new training set, which is used for a faster or more accurate training for a personalized model.

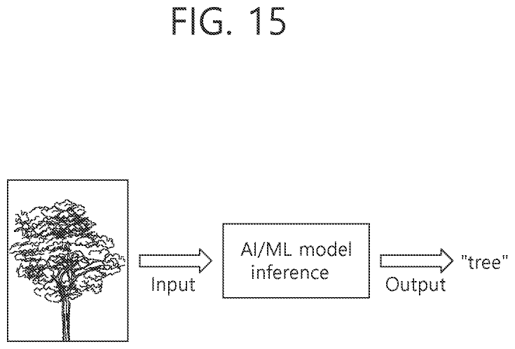

FIG. 15 shows an example of an AI/ML inference.

After a DNN is trained, it can perform its task by computing the output of the network using the weights determined during the training process, which is referred to as inference. In the model inference process, the inputs from the real world are passed through the DNN. Then the prediction for the task is output, as shown in FIG. 15. For instance, the inputs can be pixels of an image, sampled amplitudes of an audio wave or the numerical representation of the state of some system or game. Correspondingly, the outputs of the network can be a probability that an image contains a particular object, the probability that an audio sequence contains a particular word or a bounding box in an image around an object or the proposed action that should be taken.

The performance of DNNs is gained at the cost of high computational complexity. Hence more efficient compute engines are often used, e.g. graphics processing units (GPU) and network processing units (NPU). Compared to the inference which only involves the feedforward process, the training often requires more computation and storage resources because it involves also the backpropagation process.

### Widely-Used DNN Models and Algorithms

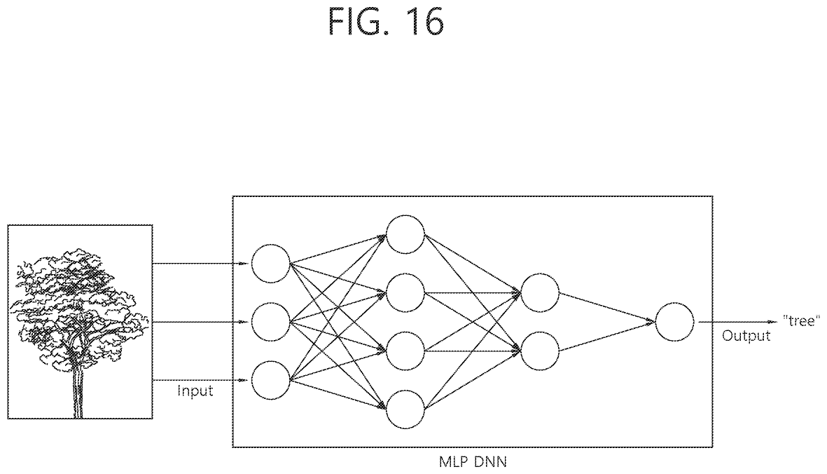

FIG. 16 shows an example of an MLP DNN model.

Many DNN models have been developed over the past two decades. Each of these models has a different “network architecture” in terms of number of layers, layer types, layer shapes (i.e., filter size, number of channels and filters), and connections between layers. FIG. 16 presents three popular structures of DNNs: multilayer perceptrons (MLPs), convolution neural networks (CNNs), and recurrent neural networks (RNNs). Multilayer perceptrons (MLP) model is the most basic DNN, which is composed of a series of fully connected layers. In a fully connected layer, all outputs are connected to all inputs, as shown in FIG. 16. Hence MLP requires a significant amount of storage and computation.

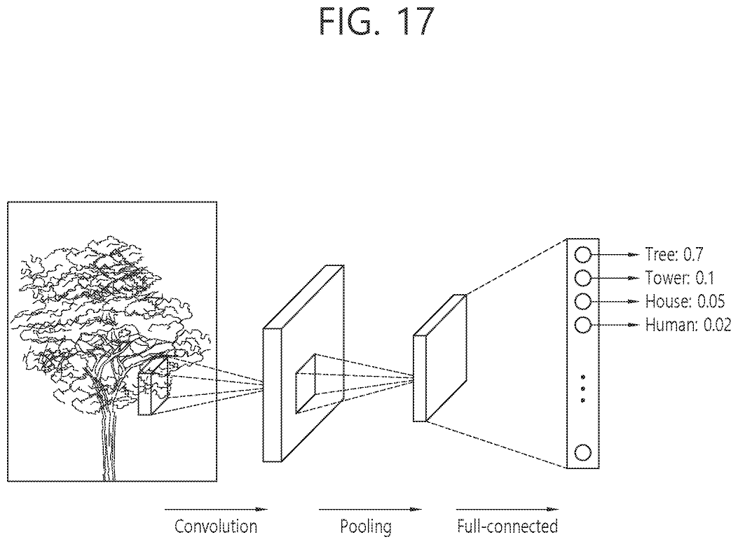

FIG. 17 shows an example of a CNN model.

An approach to limiting the number of weights that contribute to an output is to calculate the output only using a function of a fixed-size window of inputs. An extremely popular window-based DNN model uses a convolution operation to structure the computation. hence is named as convolution neural network (CNN). A CNN is composed of multiple convolutional layers, as shown in FIG. 17. Applying various convolutional filters, CNN models can capture the high-level representation of the input data, making it popular for image classification and speech recognition tasks.

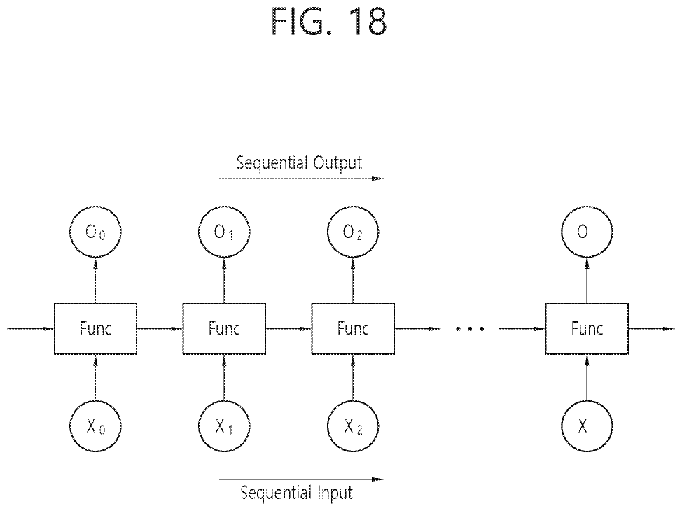

FIG. 18 shows an example of an RNN model.

Recurrent neural network (RNN) models are another type of DNNs, which use sequential data feeding. The input of RNN consists of the current input and the previous samples. Each neuron in an RNN owns an internal memory that keeps the information of the computation from the previous samples. As shown in FIG. 18, the basic unit of RNN is called cell, and further, each cell consists of layers and a series of cells enables the sequential processing of RNN models. RNN models have been widely used in the natural language processing task on mobile devices, e.g., language modelling, machine translation, question answering, word embedding, and document classification.

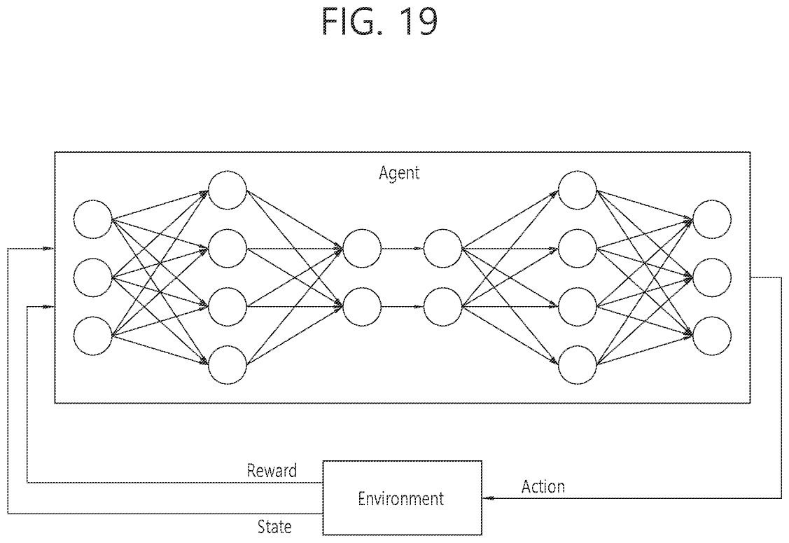

FIG. 19 shows an example of Reinforcement learning.

Deep reinforcement learning (DRL) is not another DNN model. It is composed of DNNs and reinforcement learning. As illustrated in FIG. 19, the goal of DRL is to create an intelligent agent that can perform efficient policies to maximize the rewards of long-term tasks with controllable actions. The typical application of DRL is to solve various scheduling problems, such as decision problems in games, rate selection of video transmission, and so on.

Hereinafter, technical features related to measurement report are described. Parts of section 5.5.4 and section 5.5.5 of 3GPP TS 38.331 v17.0.0 may be referred.

### Measurement Report Triggering

If AS security has been activated successfully, the UE shall:

1> for each measId included in the measdList within VarMeasConfig:

2> if the corresponding reportConfig includes a reportType set to eventTriggered

or periodical:

3> if the corresponding measObject concerns NR:

4> if the corresponding reportConfig includes measRSSI-ReportConfig:

5> consider the resource indicated by the rmtc-Config on the associated

frequency to be applicable;

4> if the eventA1 or eventA2 is configured in the corresponding reportConfig:

consider only the serving cell to be applicable;

4> if the eventA3 or eventAS is configured in the corresponding reportConfig:

5> if a serving cell is associated with a measObjectNR and neighbours are

associated with another measObjectNR, consider any serving cell associated with the other measObjectNR to be a neighbouring cell as well;

4> if corresponding reportConfig includes reportType set to periodical; or

4> for measurement events other than eventA1 or eventA2:

5> if useAllowedCellList is set to true:

6> consider any neighbouring cell detected based on parameters in the associated measObjectNR to be applicable when the concerned cell is included in the allowedCellsToAddModList defined within the VarMeasConfig for this measId;

5> else:

6> consider any neighbouring cell detected based on parameters in the associated measObjectNR to be applicable when the concerned cell is not included in the excludedCells ToAddModList defined within the VarMeasConfig for this measId;

3> else if the corresponding measObject concerns E-UTRA:

4> if eventB1 or eventB2 is configured in the corresponding reportConfig:

5> consider a serving cell, if any, on the associated E-UTRA frequency as neighbour cell;

4> consider any neighbouring cell detected on the associated frequency to be applicable when the concerned cell is not included in the excludedCells ToAddModListEUTRAN defined within the VarMeasConfig for this measId;

3> else if the corresponding measObject concerns UTRA-FDD:

4> if eventB1-UTRA-FDD or eventB2-UTRA-FDD is configured in the corresponding reportConfig; or

4> if corresponding reportConfig includes reportType set to periodical;

5> consider a neighbouring cell on the associated frequency to be applicable when the concerned cell is included in the cellsToAddModList defined within the VarMeasConfig for this measId;

3> else if the corresponding measObject concerns L2 U2N Relay UE:

4> if eventY1-Relay is configured in the corresponding reportConfig; or

4> if corresponding reportConfig includes reportType set to periodical:

5> consider any L2 U2N Relay UE detected on the associated frequency to be applicable for this measId;

2> else if the corresponding reportConfig includes a reportType set to reportCGI:

3> consider the cell detected on the associated measObject which has a physical cell identity matching the value of the cellForWhichToReportCGI included in the corresponding reportConfig within the VarMeasConfig to be applicable;

2> else if the corresponding reportConfig includes a reportType set to reportSFTD:

3> if the corresponding measObject concerns NR:

4> if the reportSFTD-Meas is set to true:

5> consider the NR PSCell to be applicable;

4> else if the reportSFTD-NeighMeas is included:

5> if cellsForWhichToReportSFTD is configured in the corresponding reportConfig:

6> consider any NR neighbouring cell detected on the associated measObjectNR which has a physical cell identity that is included in the cellsForWhichToReportSFTD to be applicable;

5> else:

6> consider up to 3 strongest NR neighbouring cells detected based on parameters in the associated measObjectNR to be applicable when the concerned cells are not included in the excludedCellsToAddModList defined within the VarMeasConfig for this measId;

3> else if the corresponding measObject concerns E-UTRA:

4> if the reportSFTD-Meas is set to true:

5> consider the E-UTRA PSCell to be applicable;

2> else if the corresponding reportConfig includes a reportType set to cli-Periodical or cli-EventTriggered:

3> consider all CLI measurement resources included in the corresponding measObject to be applicable;

2> else if the corresponding reportConfig includes a reportType set to rxTxPeriodical:

3> consider all Rx-Tx time difference measurement resources included in the corresponding measObject to be applicable;

2> if the corresponding reportConfig concerns the reporting for NR sidelink communication (i.e. reportConfigNR-SL):

3> consider the transmission resource pools indicated by the tx-PoolMeas ToAddModList defined within the VarMeasConfig for this measId to be applicable;

2> if the reportType is set to eventTriggered and if the entry condition applicable for this event, i.e, the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):

3> include a measurement reporting entry within the VarMeasReportList for this measId;

3> set the numberOfReportsSent defined within the VarMeasReportList for this measId to 0;

3> include the concerned cell(s) in the cellsTriggeredList defined within the VarMeasReportList for this measId;

3> if use T312 is set to true in reportConfig for this event:

4> if T310 for the corresponding SpCell is running; and

4> if T312 is not running for corresponding SpCell:

5> start timer T312 for the corresponding SpCell with the value of T312 configured in the corresponding measObjectNR;

3> initiate the measurement reporting procedure;

2> else if the reportType is set to eventTriggered and if the entry condition applicable for this event, i.e, the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):

3> set the numberOfReportsSent defined within the VarMeasReportList for this measId to 0;

3> include the concerned cell(s) in the cellsTriggeredList defined within the VarMeasReportList for this measId;

3> if use T312 is set to true in reportConfig for this event:

4> if T310 for the corresponding SpCell is running; and

4> if T312 is not running for corresponding SpCell:

5> start timer T312 for the corresponding SpCell with the value of T312 configured in the corresponding measObjectNR;

3> initiate the measurement reporting procedure;

2> else if the reportType is set to eventTriggered and if the leaving condition applicable for this event is fulfilled for one or more of the cells included in the cells TriggeredList defined within the VarMeasReportList for this measId for all measurements after layer 3 filtering taken during timeToTrigger defined within the VarMeasConfig for this event:

3> remove the concerned cell(s) in the cellsTriggeredList defined within the VarMeasReportList for this measId;

3> if reportOnLeave is set to true for the corresponding reporting configuration:

4> initiate the measurement reporting procedure;

3> if the cellsTriggeredList defined within the VarMeasReportList for this measId is empty:

4> remove the measurement reporting entry within the VarMeasReportList for

this measId;

4> stop the periodical reporting timer for this measId, if running;

2> if the reportType is set to eventTriggered and if the entry condition applicable for this event, i.e, the event corresponding with the eventId of the corresponding reportConfig within VarMeasConfig, is fulfilled for one or more applicable L2 U2N Relay UEs for all measurements after layer 3 filtering taken during timeToTrigger defined for this event within the VarMeasConfig, while the VarMeasReportList does not include a measurement reporting entry for this measId (a first L2 U2N Relay UE triggers the event):

3> include a measurement reporting entry within the VarMeasReportList for this

measId;

3> set the numberOfReportsSent defined within the VarMeasReportList for this measId to 0;

3> include the concerned L2 U2N Relay UE(s) in the relays TriggeredList defined within the VarMeas ReportList for this measId;

3> initiate the measurement reporting procedure;

2> else if the reportType is set to eventTriggered and if the entry condition applicable for this event, i.e, the event corresponding with the eventId of the corresponding reportConfig within VarMeasConfig, is fulfilled for one or more applicable L2 U2N Relay UEs not included in the relays TriggeredList for all measurements after layer 3 filtering taken during timeToTrigger defined for this event within the VarMeasConfig (a subsequent L2 U2N Relay UE triggers the event):

3> set the numberOfReportsSent defined within the VarMeasReportList for this measId to 0;

3> include the concerned L2 U2N Relay UE(s) in the relays TriggeredList defined within the VarMeas ReportList for this measId;

3> initiate the measurement reporting procedure;

2> else if the reportType is set to eventTriggered and if the leaving condition applicable for this event is fulfilled for one or more of the L2 U2N Relay UEs included in the relaysTriggeredList defined within the VarMeasReportList for this measId for all measurements after layer 3 filtering taken during timeToTrigger defined within the VarMeasConfig for this event:

3> remove the concerned L2 U2N Relay UE(s) in the relaysTriggeredList defined within the VarMeasReportList for this measId;

3> if reportOnLeave is set to true for the corresponding reporting configuration:

4> initiate the measurement reporting procedure;

3> if the relaysTriggeredList defined within the VarMeasReportList for this measId is empty:

4> remove the measurement reporting entry within the VarMeasReportList for this measId; 4> stop the periodical reporting timer for this measId, if running;

2> else if the reportType is set to eventTriggered and if the entry condition applicable for this event, i.e, the event corresponding with the eventId of the corresponding reportConfig within VarMeasConfig, is fulfilled for one or more applicable transmission resource pools for all measurements taken during timeToTrigger defined for this event within the VarMeasConfig, while the VarMeasReportList does not include an measurement reporting entry for this measId (a first transmission resource pool triggers the event):

3> include a measurement reporting entry within the VarMeasReportList for this measId;

3> set the numberOfReportsSent defined within the VarMeasReportList for this measId to 0;

3> include the concerned transmission resource pool(s) in the pools TriggeredList defined within the VarMeasReportList for this measId;

3> initiate the measurement reporting procedure;

2> else if the reportType is set to eventTriggered and if the entry condition applicable for this event, i.e, the event corresponding with the eventId of the corresponding reportConfig within VarMeasConfig, is fulfilled for one or more applicable transmission resource pools not included in the poolsTriggeredList for all measurements taken during timeToTrigger defined for this event within the VarMeasConfig (a subsequent transmission resource pool triggers the event):

3> set the numberOfReportsSent defined within the VarMeasReportList for this measId to 0;

3> include the concerned transmission resource pool(s) in the pools TriggeredList defined within the VarMeasReportList for this measId;

3> initiate the measurement reporting procedure;

2> else if the reportType is set to eventTriggered and if the leaving condition applicable for this event is fulfilled for one or more applicable transmission resource pools included in the pools TriggeredList defined within the VarMeasReportList for this measId for all measurements taken during timeToTrigger defined within the VarMeasConfig for this event:

3> remove the concerned transmission resource pool(s) in the pools TriggeredList defined within the VarMeasReportList for this measId;

3> if the poolsTriggeredList defined within the VarMeasReportList for this

measId is empty:

4> remove the measurement reporting entry within the VarMeasReportList for this measId;

4> stop the periodical reporting timer for this measId, if running

2> else if the reportType is set to eventTriggered and if the eventId is set to eventD1 and if the entering condition applicable for this event, i.e, the event corresponding with the eventId of the corresponding reportConfig within VarMeasConfig, is fulfilled during timeToTrigger defined within the VarMeasConfig for this event:

3> include a measurement reporting entry within the VarMeasReportList for this measId;

3> set the numberOfReportsSent defined within the VarMeasReportList for this measId to 0;

3> initiate the measurement reporting procedure;

2> if reportType is set to periodical and if a (first) measurement result is available:

3> include a measurement reporting entry within the VarMeasReportList for this measId;

3> set the numberOfReportsSent defined within the VarMeasReportList for this measId to 0;

3> if the corresponding reportConfig includes measRSSI-ReportConfig:

4> initiate the measurement reporting procedure immediately when RSSI sample values are reported by the physical layer after the first LI measurement duration;

3> else if the corresponding reportConfig includes the ul-DelayValueConfig:

4> initiate the measurement reporting procedure, immediately after a first measurement result is provided from lower layers of the associated DRB identity;

3> else if the corresponding reportConfig includes the ul-ExcessDelayConfig:

4> initiate the measurement reporting procedure, immediately after a first measurement result is provided from lower layers of the associated DRB identity(ies) according to the configured threshold per DRB identity(ies);

3> else if the reportAmount exceeds 1:

4> initiate the measurement reporting procedure, immediately after the quantity to be reported becomes available for the NR SpCell or for the serving L2 U2N Relay UE (if the UE is a L2 U2N Remote UE):

3> else (i.e. the reportAmount is equal to 1):

4> initiate the measurement reporting procedure, immediately after the quantity to be reported becomes available for the NR SpCell and for the strongest cell among the applicable cells, or for the NR SpCell and for the strongest L2 U2N Relay UEs among the applicable L2 U2N Relay UEs; or initiate the measurement reporting procedure, immediately after the quantity to be reported becomes available for the serving L2 U2N Relay UE and for the strongest cell among the applicable cells (if the UE is a L2 U2N Remote UE);

2> if, in case the corresponding reportConfig concerns the reporting for NR sidelink communication, reportType is set to periodical and if a (first) measurement result is available:

3> include a measurement reporting entry within the VarMeasReportList for this

measId;

3> set the numberOfReportsSent defined within the VarMeasReportList for this measId to 0;

3> initiate the measurement reporting procedure, immediately after the quantity to be reported becomes available for the NR SpCell and CBR measurement results become available;

2> if the reportType is set to cli-EventTriggered and if the entry condition applicable for this event, i.e, the event corresponding with the eventId of the corresponding reportConfig within VarMeasConfig, is fulfilled for one or more applicable CLI measurement resources for all measurements after layer 3 filtering taken during timeToTrigger defined for this event within the VarMeasConfig, while the VarMeasReportList does not include a measurement reporting entry for this measId (a first CLI measurement resource triggers the event):

3> include a measurement reporting entry within the VarMeasReportList for this measId;

3> set the numberOfReportsSent defined within the VarMeasReportList for this measId to 0;

3> include the concerned CLI measurement resource(s) in the cli-TriggeredList defined within the VarMeasReportList for this measId;

3> initiate the measurement reporting procedure;

2> else if the reportType is set to cli-EventTriggered and if the entry condition applicable for this event, i.e, the event corresponding with the eventId of the corresponding reportConfig within VarMeasConfig, is fulfilled for one or more CLI measurement resources not included in the cli-TriggeredList for all measurements after layer 3 filtering taken during timeToTrigger defined for this event within the VarMeasConfig (a subsequent CLI measurement resource triggers the event):

3> set the numberOfReportsSent defined within the VarMeasReportList for this measId to 0;

3> include the concerned CLI measurement resource(s) in the cli-TriggeredList defined within the VarMeasReportList for this measId;

3> initiate the measurement reporting procedure;

2> else if the reportType is set to cli-EventTriggered and if the leaving condition applicable for this event is fulfilled for one or more of the CLI measurement resources included in the cli-TriggeredList defined within the VarMeasReportList for this measId for all measurements after layer 3 filtering taken during timeToTrigger defined within the VarMeasConfig for this event:

3> remove the concerned CLI measurement resource(s) in the cli-TriggeredList defined within the VarMeasReportList for this measId;

3> if reportOnLeave is set to true for the corresponding reporting configuration:

4> initiate the measurement reporting procedure;

3> if the cli-TriggeredList defined within the VarMeasReportList for this measId is empty:

4 remove the measurement reporting entry within the VarMeasReportList for this measId;

4> stop the periodical reporting timer for this measId, if running;

2> if reportType is set to cli-Periodical and if a (first) measurement result is available:

3> include a measurement reporting entry within the VarMeasReportList for this measId;

3> set the numberOfReportsSent defined within the VarMeasReportList for this measId to 0;

3> initiate the measurement reporting procedure, immediately after the quantity to be reported becomes available for at least one CLI measurement resource;

2> if reportType is set to rxTxPeriodical and if a (first) measurement result is available:

3> include a measurement reporting entry within the VarMeasReportList for this measId;

3> set the numberOfReportsSent defined within the VarMeasReportList for this measId to 0;

3> initiate the measurement reporting procedure;

2> upon expiry of the periodical reporting timer for this measId:

3> initiate the measurement reporting procedure.

2> if the corresponding reportConfig includes a reportType is set to reportSFTD:

3> if the corresponding measObject concerns NR:

4> if the drx-SFTD-NeighMeas is included:

5> if the quantity to be reported becomes available for each requested pair of PCell and NR cell:

6> stop timer T322;

6> initiate the measurement reporting procedure;

4> else

5> initiate the measurement reporting procedure, immediately after the quantity to be reported becomes available for each requested pair of PCell and NR cell or the maximal measurement reporting delay as specified in TS 38.133 [14];

3> else if the corresponding measObject concerns E-UTRA:

4> initiate the measurement reporting procedure, immediately after the quantity

to be reported becomes available for the pair of PCell and E-UTRA PSCell or the maximal measurement reporting delay as specified in TS 38.133 [14];

2> if reportType is set to reportCGI:

3> if the UE acquired the SIB1 or SystemInformationBlockType1 for the requested cell; or

3> if the UE detects that the requested NR cell is not transmitting SIB1 (see TS 38.213 [13], clause 13):

4> stop timer T321;

4> include a measurement reporting entry within the VarMeasReportList for this measId;

4> set the numberOfReportsSent defined within the VarMeasReportList for this measId to 0;

4> initiate the measurement reporting procedure;

2> upon the expiry of T321 for this measId:

3> include a measurement reporting entry within the VarMeasReportList for this measId;

3> set the numberOfReportsSent defined within the VarMeasReportList for this measId to 0;

3> initiate the measurement reporting procedure.

2> upon the expiry of T322 for this measId:

3> initiate the measurement reporting procedure.

Events are as follows:
Event A1: Serving becomes better than threshold
Event A2: Serving becomes worse than threshold
Event A3: Neighbour becomes offset better than SpCell
Event A4: Neighbour becomes better than threshold
Event A5: SpCell becomes worse than threshold1 and neighbour becomes better than threshold2
Event A6: Neighbour becomes offset better than SCell
Event B1: Inter RAT neighbour becomes better than threshold
Event B2: PCell becomes worse than threshold1 and inter RAT neighbour becomes better than threshold2
Event I1: Interference becomes higher than threshold
Event C1: The NR sidelink channel busy ratio is above a threshold
Event C2: The NR sidelink channel busy ratio is below a threshold
Event X1: Serving L2 U2N Relay UE becomes worse than threshold1 and NR Cell becomes better than threshold2
Event X2: Serving L2 U2N Relay UE becomes worse than threshold
Event Y1: PCell becomes worse than threshold1 and candidate L2 U2N Relay UE becomes better than threshold2
Event Y2: Candidate L2 U2N Relay UE becomes better than threshold

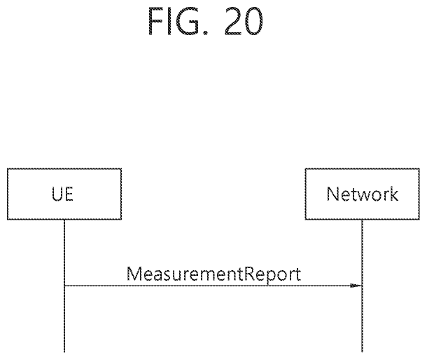

FIG. 20 shows an example of measurement reporting.

The purpose of this procedure is to transfer measurement results from the UE to the network. The UE shall initiate this procedure only after successful AS security activation.

For the measId for which the measurement reporting procedure was triggered, the UE shall set the measResults within the MeasurementReport message as follows:

1> set the measId to the measurement identity that triggered the measurement reporting;

1> for each serving cell configured with servingCellMO:

2> if the reportConfig associated with the measId that triggered the measurement

reporting includes rsType:

3> if the serving cell measurements based on the rsType included in the reportConfig that triggered the measurement report are available:

set the measResultServingCell within measResultServingMOList to include RSRP, RSRQ and the available SINR of the serving cell, derived based on the rsType included in the reportConfig that triggered the measurement report;

2> else:

3> if SSB based serving cell measurements are available:

4> set the measResultServingCell within measResultServingMOList to include RSRP, RSRQ and the available SINR of the serving cell, derived based on SSB;

3> else if CSI-RS based serving cell measurements are available:

4> set the measResultServingCell within measResultServingMOList to include RSRP, RSRQ and the available SINR of the serving cell, derived based on CSI-RS;

1> set the servCellId within measResultServingMOList to include each NR serving cell that is configured with servingCellMO, if any;

1> if the reportConfig associated with the measId that triggered the measurement reporting includes reportQuantityRS-Indexes and maxNrofRS-Indexes ToReport:

2> for each serving cell configured with servingCellMO, include beam measurement information according to the associated reportConfig;

1> if the reportConfig associated with the measId that triggered the measurement reporting includes reportAddNeighMeas:

2> for each measObjectId referenced in the measIdList which is also referenced with servingCellMO, other than the measObjectId corresponding with the measId that triggered the measurement reporting:

3> if the measObjectNR indicated by the servingCellMO includes the RS resource configuration corresponding to the rsType indicated in the reportConfig:

4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;

4> if the reportConfig associated with the measId that triggered the measurement reporting includes reportQuantityRS-Indexes and maxNrofRS-Indexes ToReport:

5> for each best non-serving cell included in the measurement report:

6> include beam measurement information according to the associated reportConfig;

### Reporting of Beam Measurement Information

For beam measurement information to be included in a measurement report the UE shall:

1> if reportType is set to eventTriggered:

2> consider the trigger quantity as the sorting quantity if available, otherwise

RSRP as sorting quantity if available, otherwise RSRQ as sorting quantity if available, otherwise SINR as sorting quantity;

1> if reportType is set to periodical:

2> if a single reporting quantity is set to true in reportQuantityRS-Indexes;

3> consider the configured single quantity as the sorting quantity;

2> else:

3> if rsrp is set to true;

4> consider RSRP as the sorting quantity;

3> else:

4> consider RSRQ as the sorting quantity;

1> set rsIndexResults to include up to maxNrofRS-IndexesToReport SS/PBCH block indexes or CSI-RS indexes in order of decreasing sorting quantity as follows:

2> if the measurement information to be included is based on SS/PBCH block:

3> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;

3> if includeBeamMeasurements is set to true, include the SS/PBCH based measurement results for the quantities in reportQuantityRS-Indexes for each SS/PBCH block index;

2> else if the beam measurement information to be included is based on CSI-RS:

3> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;

3> if includeBeamMeasurements is set to true, include the CSI-RS based measurement results for the quantities in reportQuantityRS-Indexes for each CSI-RS index.

Hereinafter, technical features related to network energy saving solution are described.

For example, techniques and enhancements on assistance information from the UE to aid the gNB to perform energy saving techniques are as below.

Some examples of assistance information are, but not limited to:
preferred SSB configurations,
indication of semi-static UL channel transmissions.
indication of UE's buffer status for UL channel transmissions,
UE traffic information such as service priority, delay tolerance, data rate, data volume, traffic type, time criticality, and packet size(s).
coverage, mobility status, location.
conditions for triggering the assistance information from the UE

### Network Energy Saving

To meet the 5G network requirements of key performance and the demands of the unprecedented growth of the mobile subscribers, millions of base stations (BSs) are being deployed. Such rapid growth brings the issues of high energy consumption, CO₂ emissions and operation expenditures (OPEX). Therefore, energy saving is an important use case which may involve different layers of the network, with mechanisms operating at different time scales.

Cell activation/deactivation is an energy saving scheme in the spatial domain that exploits traffic offloading in a layered structure to reduce the energy consumption of the whole radio access network (RAN). When the expected traffic volume is lower than a fixed threshold. the cells may be switched off, and the served Ues may be offloaded to a new target cell.

Efficient energy consumption can also be achieved by other means such as reduction of load, coverage modification, or other RAN configuration adjustments. The optimal energy saving decision depends on many factors including the load situation at different RAN nodes,

RAN nodes capabilities, KPI/QoS requirements, number of active Ues and UE mobility, cell utilization, etc.

However, the identification of actions aimed at energy efficiency improvements is not a trivial task. Wrong switch-off of the cells may seriously deteriorate the network performance since the remaining active cells need to serve the additional traffic. Wrong traffic offload actions may lead to a deterioration of energy efficiency instead of an improvement. The current energy-saving schemes are vulnerable to potential issues listed as follows:
Inaccurate cell load prediction. Currently, energy-saving decisions rely on current traffic load without considering future traffic load.
Conflicting targets between system performance and energy efficiency. Maximizing the system's key performance indicator (KPI) is usually done at the expense of energy efficiency. Similarly, the most energy efficient solution may impact system performance. Thus, there is a need to balance and manage the trade-off between the two.
Conventional energy-saving related parameters adjustment. Energy-saving related parameters configuration is set by traditional operation, e.g., based on different thresholds of cell load for cell switch on/off which is somewhat a rigid mechanism since it is difficult to set a reasonable threshold.
Actions that may produce a local (e.g., limited to a single RAN node) improvement of Energy Efficiency, while producing an overall (e.g., involving multiple RAN nodes) deterioration of Energy Efficiency.

To deal with issues listed above, ML techniques could be utilized to optimize the energy saving decisions by leveraging on the data collected in the RAN network. ML algorithms may predict the energy efficiency and load state of the next period, which can be used to make better decisions on cell activation/deactivation for energy saving. Based on the predicted load, the system may dynamically configure the energy-saving strategy (e.g., the switch-off timing and granularity, offloading actions) to keep a balance between system performance and energy efficiency and to reduce the energy consumption.

### Solutions and Standard Impacts

Locations for AI/ML Model Training and AI/ML Model Inference

The following solutions can be considered for supporting AI/ML-based network energy saving:
AI/ML Model Training is located in the OAM and AI/ML Model Inference is located in the gNB.
AI/ML Model Training and AI/ML Model Inference are both located in the gNB.

gNB is also allowed to continue model training based on AI/ML model trained in the OAM

In case of CU-DU split architecture, the following solutions are possible:
AI/ML Model Training is located in the OAM and AI/ML Model Inference is located in the gNB-CU.
AI/ML Model Training and Model Inference are both located in the gNB-CU.

### AI/ML Model Training at OAM and AI/ML Model Inference at NG-RAN

In this solution, NG-RAN makes energy decisions using AI/ML model trained from OAM.

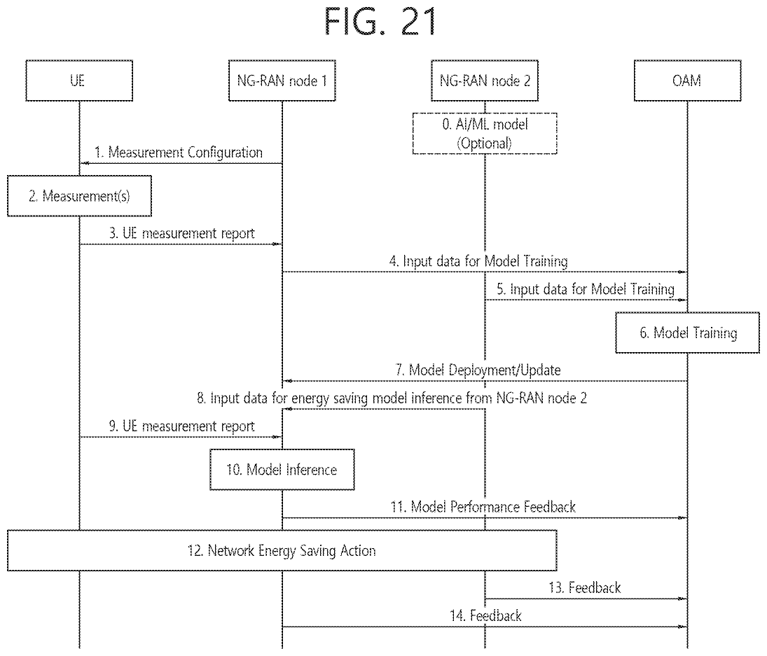

FIG. 21 shows an example of Model Training at OAM, Model Inference at NG-RAN.

Step 0: NG-RAN node 2 is assumed to have an AI/ML model optionally, which can provide NG-RAN node 1 with input information.

Step 1: NG-RAN node 1 configures the measurement information on the UE side and sends configuration message to UE to perform measurement procedure and reporting.

Step 2: The UE collects the indicated measurement(s), e.g., UE measurements related to RSRP. RSRQ, SINR of serving cell and neighbouring cells.

Step 3: The UE sends the measurement report message(s) to NG-RAN node 1.

Step 4: NG-RAN node 1 further sends UE measurement reports together with other input data for Model Training to OAM.

Step 5: NG-RAN node 2 (assumed to have an AI/ML model optionally) also sends

input data for Model Training to OAM.

Step 6: Model Training at OAM. Required measurements and input data from other NG-RAN nodes are leveraged to train AI/ML models for network energy saving.

Step 7: OAM deploys/updates AI/ML model into the NG-RAN node(s). The NG-RAN node can also continue model training based on the received AI/ML model from OAM.

Note: This step is out of RAN3 Rel-17 scope.

Step 8: NG-RAN node 2 sends the required input data to NG-RAN node 1 for model inference of AI/ML-based network energy saving.

Step 9: UE sends the UE measurement report(s) to NG-RAN node 1.

Step 10: Based on local inputs of NG-RAN node 1 and received inputs from NG-RAN node 2, NG-RAN node 1 generates model inference output(s) (e.g., energy saving strategy, handover strategy, etc).

Step 11: NG-RAN node 1 sends Model Performance Feedback to OAM if applicable.

Note: This step is out of RAN3 scope.

Step 12: NG-RAN node 1 executes Network energy saving actions according to the model inference output. NG-RAN node 1 may select the most appropriate target cell for each UE before it performs handover, if the output is handover strategy.

Step 13: NG-RAN node 2 provides feedback to OAM.

Step 14: NG-RAN node 1 provides feedback to OAM.

### AI/ML Model Training and AI/ML Model Inference at NG-RAN

In this solution. NG-RAN is responsible for model training and generates energy saving decisions.

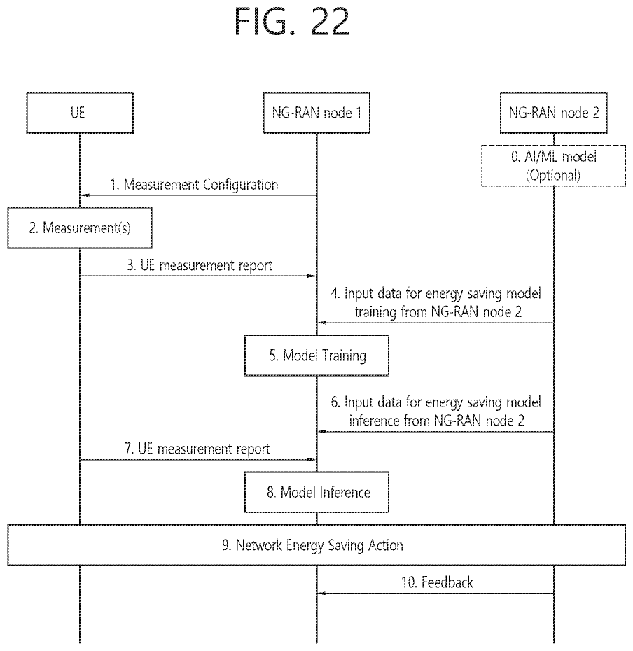

FIG. 22 shows an example of Model Training and Model Inference at NG-RAN

Step 0: NG-RAN node 2 is assumed to have an AI/ML model optionally, which can provide NG-RAN node 1 with input information.

Step 1: NG-RAN node 1 configures the measurement information on the UE side and sends configuration message to UE to perform measurement procedure and reporting.

Step 2: The UE collects the indicated measurement(s), e.g., UE measurements related to RSRP, RSRQ. SINR of serving cell and neighbouring cells.

Step 3: The UE sends the measurement report(s) to NG-RAN node 1 including the required measurement result.

Step 4: NG-RAN node 2 sends the required input data to NG-RAN node 1 for model training of AI/ML-based network energy saving.

Step 5: NG-RAN node 1 trains AI/ML model for AI/ML-based energy saving based on collected data. NG-RAN node 2 is assumed to have AI/ML model for AI/ML-based energy saving optionally, which can also generate predicted results/actions.

Step 6: NG-RAN node 2 sends the required input data to NG-RAN node 1 for model inference of AI/ML-based network energy saving.

Step 7: UE sends the UE measurement report(s) to NG-RAN node 1.

Step 8: Based on local inputs of NG-RAN node 1 and received inputs from NG-RAN node 2, NG-RAN node 1 generates model inference output (e.g., energy saving strategy, handover strategy, etc).

Step 9: NG-RAN node 1 executes Network energy saving actions according to the model inference output. NG-RAN node 1 may select the most appropriate target cell for each UE before it performs handover, if the output is handover strategy.

Step 10: NG-RAN node 2 provides feedback to NG-RAN node 1.

### Input of AI/ML-Based Network Energy Saving

To predict the optimized network energy saving decisions, NG-RAN may need following information as input data for AI/ML-based network energy saving:

### From Local Node

UE mobility/trajectory prediction
Current/Predicted Energy efficiency
Current/Predicted resource status

### From the UE

UE location information (e.g., coordinates, serving cell ID, moving velocity) interpreted by gNB implementation when available
UE measurement report (e.g., UE RSRP, RSRQ, SINR measurement, etc), including cell level and beam level UE measurements

### From Neighbouring NG-RAN Nodes

Current/Predicted energy efficiency
Current/Predicted resource status
Current energy state (e.g., active, high, low, inactive)

If existing UE measurements are needed by a gNB for AI/ML-based network energy saving. RAN3 shall reuse the existing framework (including MDT and RRM measurements).

### Output of AI/ML-Based Network Energy Saving

AI/ML-based network energy saving model can generate following information as output:
Energy saving strategy, such as recommended cell activation/deactivation.
Handover strategy, including recommended candidate cells for taking over the traffic
Predicted energy efficiency
Predicted energy state (e.g., active, high, low, inactive)
Model output validity time will be discussed during R18 normative work per inference output.

### Feedback of AI/ML-Based Network Energy Saving

To optimize the performance of AI/ML-based network energy saving model, following feedback can be considered to be collected from NG-RAN nodes:
Resource status of neighbouring NG-RAN nodes
Energy efficiency
UE performance affected by the energy saving action (e.g., banded-over UEs), including bitrate, packet loss, latency.
System KPIs (e.g., throughput, delay, RLF of current and neighbouring NG-RAN node)

### Standard Impact

MDT procedure enhancements should be discussed during the normative phase.

### Potential Xn Interface Impact

New signalling procedure or enhanced existing procedure to collect the input data information
Predicted energy efficiency between neighbouring NG-RAN nodes and source NG-RAN node
Predicted resource status between neighbouring NG-RAN nodes and source NG-RAN node
New signalling procedure or enhanced existing procedure to retrieve feedback information

Meanwhile, the application of AI/ML to wireless communication has been studied to improve overall network and UE operation for performance and the ability to provide various services. Using AI/ML, both networks and UEs can predict mobility and share the results to improve performance.

From the point of view of network energy saving (NES), it aims to reduce the unnecessary resources not used from UEs according to the UE's assistance information. For example, if the amount of data traffic required from UEs is less, the network can activate a narrow bandwidth BWP only or de-configure the CG/SPS, if configured.

In some cases, the network can even turn off the network for power saving. However, wrong switch-off the cells or reducing resources can seriously deteriorate the UE performance. It can also affect neighbour cells by burdening them to serve the additional traffic. That is, wrong NES decision may make negative effect instead of an improvement.

To carefully decide the NES state, ML can be utilized to optimize the decision by collecting the predictive UE's assistance information on future traffic information. It can help to decide the start time of NES activation/deactivation and appropriate duration of each state. It can also help optimize the appropriate allocation of network resources reserved for each future time.

Future traffic information can be used by network to determine DRX parameters to better balance between packet transmission latency and UE power saving. Future traffic information can be also used to determine a suitable RRC state to balance among packet transmission latency, signalling overhead and UE power saving. Future traffic information, or it can be used to choose an optimal scheduling policy or scheduling resources. The information can be used by network to activate one or more serving cell or cell group configured in the UE for a certain time duration for power saving.

However, the if UE sends the future traffic information too frequently or report the future traffic information that are not meaningful, it places a signalling burden on both the UE and the network. Network may disable/turn-off the reporting of the future traffic just to avoid the signalling overhead, instead of exploiting the prediction capabilities of the UE.

Therefore, studies for reporting data traffic based on prediction in a wireless communication system are required.

Hereinafter, a method for reporting data traffic based on prediction in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

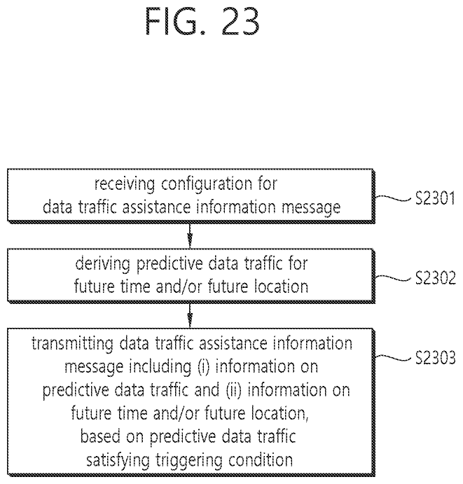

FIG. 23 shows an example of a method for reporting data traffic based on prediction in a wireless communication system.

In particular, FIG. 23 shows an example of a method performed by a wireless device in a wireless communication system.

In step S2301, a wireless device may receive, from a network, a configuration for a data traffic assistance information message.

The configuration may include a triggering condition for the data traffic assistance information message.

For example, the triggering condition may include a condition which is satisfied based on that an amount of the predictive data traffic is equal to or greater than a threshold value.

For example, the triggering condition may include a condition which is satisfied based on that an amount of the predictive data traffic is less than a threshold value.

For example, the triggering condition may include a condition related to a time value at which the predictive data traffic is driven.

For example, the triggering condition may include a condition related to a location value on which the predictive data traffic is driven.

For example, the triggering condition may include a condition related to a data type of the predictive data traffic.

For example, the triggering condition may include a condition related to a latency of the predictive data traffic.

According to some embodiments of the present disclosure, the wireless device may receive, from the network, a configuration related to a Machine Learning (ML) model to be used for deriving the predictive data traffic. The wireless device may use the ML model in step S2302 below.

In step S2302, a wireless device may derive a predictive data traffic for a future time and/or a future location.

In step S2303, based on the predictive data traffic satisfying the triggering condition, a wireless device may transmit the data traffic assistance information message including (i) information on the predictive data traffic and (ii) information on the future time and/or the future location.

For example, the information on the predictive data traffic may include information on service priority, delay tolerance, data rate, data volume, traffic type, time criticality, and/or packet size(s) of traffic in the wireless device.

According to some embodiments of the present disclosure, the wireless device may derive a predictive future time and/or a predictive future location in which another predictive data traffic satisfies the triggering condition.

For example, the data traffic assistance information message includes (i) information on the predictive future time and/or the predictive future location and/or (ii) information on the other predictive data traffic.

According to some embodiments of the present disclosure, the wireless device may be in communication with at least one of a user equipment, a network, or an autonomous vehicle other than the wireless device.

Hereinafter, some embodiments of a method for reporting data traffic based on prediction in a wireless communication system are described.

In the present disclosure, a method for sending the assistance information of predictive data traffic is provided. The network may configure the threshold for a certain data traffic type such as data rate, data volume. The UE may derive prediction data traffic results for a future time/location. If the prediction data traffic result satisfies the threshold, the UE may report the prediction results. Then the network can apply the prediction results to determine the NES state for the future.

According to some embodiments of the present disclosure, a UE may receive, from a network, a configuration for data traffic assistance information.

For example, the configuration may include one or more applicable conditions for predictive data traffic as follows:
the condition may include a threshold for evaluating the data traffic
the condition may include a time value for deriving the data traffic
the condition may include a location value for deriving the data traffic
the condition may include a reporting periodicity

For example, the configuration may include a data bearer for deriving the data traffic.

For example, the configuration may include report type(s) of data traffic, for example, service priority, delay tolerance, data rate, data volume, traffic type, time criticality, and packet size(s).

A UE may derive the data traffic results based on the condition for a future time. For example, UE may derive the data traffic at the time of the time value.

For example, UE may derive the data traffic at the location of the location value.

For example, UE may derive the time that satisfies the threshold.

For example, UE may derive the location that satisfies the threshold.

A UE may send the data traffic assistance information if the data traffic results satisfy the condition.

For example, UE may include the time information where the condition is met.

For example, UE may include the location information where the condition is met.

For example, UE may include the data traffic information based on the report type(s), if configured.

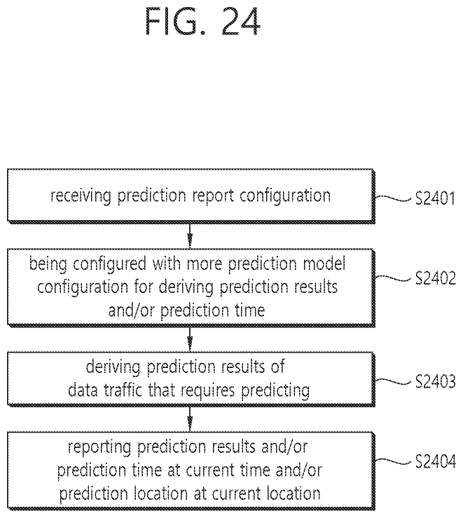

FIG. 24 shows an example of a method for reporting data traffic based on prediction in a wireless communication system.

In particular, FIG. 24 shows an example of a method performed by a UE in a wireless communication system.

In step S2401, a UE may receive, from a network, a prediction report configuration. In other words, a network may configure UE with prediction report configuration.

1> The prediction report configuration may be included in measurement configuration including measurement object(s) and measurement reporting condition(s).

1> The prediction report configuration may be included in conditional mobility configuration including conditional reconfiguration(s) and execution condition(s).

1> The prediction report configuration may be included in other configurations for a UE assistance information message.

1> The prediction report configuration may be included in UE information request message.

1> Each prediction report configuration may include information about data traffic type that requires predicting.

2> For example, Service priority, delay tolerance, data rate, data volume, traffic type, time criticality, and packet size(s)

2> It may include the target data bearer

2> It may include the target network slice

2> It may include the target traffic type

2> It may include the target QOS flow

1> Each prediction report configuration may include threshold information as report conditions.

2> Each example is applicable to both DL and UL

3> For example, packet arrival at a certain time

3> For example, data packet size or data volume (e.g., A bytes)

3> For example, data rate (e.g., B bps)

3> For example, latency budget

3> For example, traffic type or specific QOS flow

1> Each prediction report configuration may include the prediction time information.

2> The prediction time information may include a prediction time value, T1.

2> The prediction time information may include a prediction time window-related parameter T2.

3> The prediction time parameter indicates the start time of prediction window (T2_min) in the example below)

3> The prediction time parameter indicates the end time of prediction window (T2_max) in the example below)

1> Each prediction report configuration may include the prediction location information.

2> The prediction time information may include a prediction location value, L1.

2> For examples,

3> Polygon type information

4> Polygon type information may include ordered series of points for a geographic shape

3> Latitude/longitude information

4> Latitude/longitude information may include a point at a specific distance

4> Latitude/longitude information may include degree information

4> Latitude/longitude information may include the direction (vector located in 2D coordinate axes)

4> Coordinate information

3> Altitude information

4> Altitude information may include a point at a specific distance

4> Altitude information may include the direction (vector located in 3D coordinate axes)

4> Coordinate information

3> Velocity information

4> Velocity information may include the vertical speed

4> Velocity information may include the horizontal speed

4> Velocity information may include the direction (vector located in 2D/3D coordinate axes)

4> Coordinate information

3> Cell information

4> The cell information includes a list of cell information, where the UE reports the prediction results if the listed cell is one of serving cell(s) configured in the UE.

4> The cell information of each cell may comprise {physical cell ID, frequency} or global cell ID.

1> Each prediction report configuration may include the reporting periodicity information for periodic report.

In step S2402, a UE may be configured with a more prediction model configuration, for deriving the prediction results and/or the prediction time.

1> The prediction model configuration may include prediction model structure information,

2> Network may configure a machine learning model to be used by UE.

3> Network may include a machine learning type, such as reinforcement learning, supervised learning, or unsupervised learning.

3> Network may include a machine learning model, such as DNN. CNN, RNN, and DRL.

3> The configured ML model may be a pre-trained ML model that has been already trained by network a-priori

4> The configured ML model is described by a model description information including model structure and parameters.

4> For example, neural-network based model may comprise input layer, output layer, and hidden layer(s), where each layer comprises one or more neurons (equivalently nodes).

5> Different layers are connected based on the connections between neurons of different layers

5> Each connection of two different neurons in two different layers may be directive (e.g. neuron A to neuron B, meaning that the output of neuron A is fed into the neuron B)

5> Each neuron may provide input to one or several connected neurons (1 to N connection).

5> For a connection between two neurons (neuron A to neuron B), output of one neuron (A) is scaled by a weight, and the other neuron takes the scaled output as its input.

5> Each neuron may take input from one or several connected neurons (N to 1connection), and combines the input from the connected neurons, and produces an output based on activation function.

3> The configured ML model may be a ML model to be trained.

4> The configured ML model is described by a model description information including model structure and initial parameters that are to be trained.

4> When network configures the ML model to be trained, it may also configure training parameters such as optimization objective(s) and optimization-related configuration parameters.

3> Network may include machine learning input parameters for the machine learning model, such as UE location information, radio measurements related to serving cell and neighbouring cells, UE mobility history.

3> Network may include machine learning output, such as UE trajectory prediction. predicted target cell, prediction time for handover, and UE traffic prediction.

2> UE may perform a machine learning model training, validation, and testing which may generate model performance metrics based on the prediction model configuration.

3> UE may perform a model training with the machine learning input parameters.

2> UE may use the configured ML model to perform ML task such as predictions of measurements.

3> UE may derive machine learning output(s).

3> UE may infer from the outputs and use the outputs as feedback for the machine learning model.

2> UE may send feedback to network about the results related to machine learning outputs and the accuracy of the machine learning model.

3> Network may update the machine learning model and parameters related to the machine learning model.

In step S2403, a UE may derive the prediction results of data traffic that requires predicting as followings:

In step S2403-1, a UE may derive the prediction results of data traffic for future time based on the time information and configured ML model.

1> UE may derive the prediction results based on prediction time information associated with the data traffic

2> For example, at the current time to, if T1 is configured, UE may derive the prediction results for the time t0+T1.

2> For example, at the current time to, if T2 related to the start time of prediction window (T2_min) is configured, UE may derive the prediction results for the time period [t0+T2. ∞].

2> For example, at the current time to, if T2 related to the end time of prediction window (T2_max) is configured, UE may derive the prediction results for the time period [t0, t0+T1].

2> To derive prediction results, UE may apply the configured prediction model.

In step S2403-2, a UE may derive the prediction results of data traffic for future location based on the location information and configured ML model.

1> UE may derive the prediction results based on prediction location information associated with the data traffic

2> For example, at the current time 10, if L1 is configured, UE may derive the prediction results for the location L1.

2> To derive prediction results, UE may apply the configured prediction model.

In step S2403-3, a UE may derive the prediction time and prediction results of data traffic for future time that satisfies the threshold of the threshold information based on configured ML model.

1> UE may derive the prediction results based on the threshold associated with the data traffic

2> UE may derive the prediction time t_prediction at which the prediction result is predicted to satisfy the threshold

2> UE may derive the predicted results, denoted by P^{t_prediction} (t_0), where P^{y} (x) indicates the predictive data traffic result of the prediction target derived at time x for future time y.

In step S2403-4, a UE may derive the prediction location and prediction results of data traffic for future location that satisfies the threshold of the threshold information based on configured ML model.

1> UE may derive the prediction results based on the threshold associated with the data traffic

2> UE may derive the prediction time I_prediction at which the prediction result is predicted to satisfy the threshold

2> UE may derive the predicted results, denoted by Pl_prediction (l_0), where Py (x) indicates the predictive data traffic result of the prediction target derived at location x for future location y.

In step S2404, a UE may report the prediction results and/or the prediction time at current time t_current and/or the prediction location at current location l_current.

1> (Periodic report) The report may send periodically based on the reporting periodicity information

1> (Event based report) The report may send on at least one of conditions as follows:

2> Based on the threshold information

2> Based on the time information

2> Based on the location information

1> The report may include the prediction results (Based on time/location information)

2> Prediction results for a certain time T1, P^{t_1} (t_current)

2> Prediction results for a certain time duration T2, P^{t_2} (t_current)

2> Prediction results for a certain location L1, P^{1_1} (t_current)

1> The report may include the prediction time t_prediction that satisfies the threshold (Based on the threshold)

2> The report may include the prediction results, P^{t_prediction} (t_current).

1> The report may include the prediction location l_prediction that satisfies the threshold. (Based on the threshold)

2> The report may include the prediction results, P^{l_prediction} (t_current).

2> The prediction location may include at least one of the following:

3> Polygon type information

4> Polygon type information may include ordered series of points for a geographic shape

3> Latitude/longitude information

4> Latitude/longitude information may include a point at a specific distance

4> Latitude/longitude information may include degree information

4> Latitude/longitude information may include the direction (vector located in 2D coordinate axes)

4> Coordinate information

3> Altitude information

4> Altitude information may include a point at a specific distance

4> Altitude information may include the direction (vector located in 3D coordinate axes)

4> Coordinate information

3> Velocity information

4> Velocity information may include the vertical speed

4> Velocity information may include the horizontal speed

4> Velocity information may include the direction (vector located in 2D/3D coordinate axes)

4> Coordinate information

3> Cell information

4> The cell information where the UE reports the prediction results

4> The cell information of each cell may comprise {physical cell ID, frequency} or global cell ID.

1> Each prediction result may include data traffic information such as Service priority, delay tolerance, data rate, data volume, traffic type, time criticality, and packet size(s)

1> The prediction report may be included in measurement report message

2> The measurement report may include the predictive signal strength for the associated time/location of prediction results

1> The prediction report may be included in RRCReconfigurationComplete message for the Conditional mobility

1> The prediction report may be included in UE assistance information message

1> The prediction report may be included in UE information response message.

1> The prediction report may be transmitted via inter-CG/Cell/Beam

Hereinafter, some examples for reporting data traffic based on prediction are described.

### Packet Arrival Prediction

UE may predict packet arrival for a specific time
   UE in time t predicts if DL traffic arrival in time t+T at network side (e.g., RAN) is expected to occur and reports the prediction results to network.
   UE at time t predicts if UL traffic arrival in time T at UE is expected to occur and reports the prediction results to network.
UE may predict packet arrival for a specific time duration
   UE in time t predicts when DL traffic arrivals during the time duration {t+T1, t+T2} at network side (e.g., RAN) are expected to occur or not occur and reports the prediction results to network.
   UE in time t predicts when UL traffic arrivals during the time duration {t+T1, t+T2} at UE side are expected to occur or not occur and reports the prediction results to network.

For the prediction of the packet arrival,
The prediction result may be true (packet arrival)/false (no packet arrival) for the concerned time moment/duration
The prediction result may be probability of the packet arrival for the concerned time moment/duration.
In case the prediction task is performed for a time duration, the UE may produce a series of prediction results, each of which corresponds to each time moment included in the time duration.

When predicting the future packet arrival, the UE may further predict the traffic type (associated to a certain QoS requirement) of the packet arrival. Equivalently the UE may predict the packet arrival per each traffic type or per QoS flow. When predicting the future packet arrival, the UE may further predict the data volume of the packet arrival. Then, the UE may also report the traffic type/data volume for the future packet arrival.

The reporting of the prediction results may be event-based. For example, the UE may be configured with one or more reporting conditions associated with the prediction. If the configured condition is met, the UE sends a reporting including the prediction results to network. As an example of such reporting conditions, the following may be considered:

### Packet Arrival Condition

Packet will arrive at a certain time T after the current time
Packet will arrive during a certain time window including future times
Packet will not arrive until at a certain time T after the current time
Packet will not arrive during a certain time window including future times

### Data Volume Condition

Data with a data volume larger than a threshold will arrive at a certain time T after the current time
Data with a data volume larger than a threshold will arrive during a certain time window including future times

### Latency Condition

Data with a latency budget smaller than a threshold will arrive at a certain time T after the current time
Data with a latency budget smaller than a threshold will arrive during a certain time window including future times
Data with a latency budget larger than a threshold will arrive at a certain time T after the current time
Data with a latency budget larger than a threshold will arrive during a certain time window including future times

The reporting of the prediction results may be periodic with a configured reporting periodicity.

The reporting of the prediction results may be event-based. For example, the UE may be configured with a reporting condition associated with the prediction. If the condition is met, the UE sends a reporting including the prediction results to network.

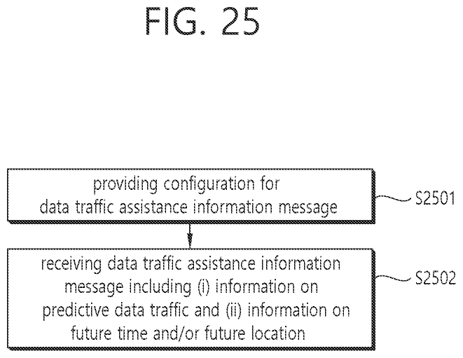

FIG. 25 shows an example of a method for the predictive data traffic report performed by a base station (BS).

The BS may include a transceiver, a memory, and a processor operatively coupled to the transceiver and the memory.

In step S2501, a BS may provide, to a wireless device, a configuration for a data traffic assistance information message.

For example, the configuration may include a triggering condition for the data traffic assistance information message.

In step S2502, a BS may receive, from the wireless device, the data traffic assistance information message including (i) information on a predictive data traffic and (ii) information on a future time and/or a future location.

For example, the predictive data traffic may be derived by the wireless device based on the future time and/or the future location.

Some of the detailed steps shown in the examples of FIGS. 23, 24, and 25 may not be essential steps and may be omitted. In addition to the steps shown in FIGS. 23, 24, and 25, other steps may be added, and the order of the steps may vary. Some of the above steps may have their own technical meaning.

Hereinafter, an apparatus for reporting data traffic based on prediction in a wireless communication system, according to some embodiments of the present disclosure, will be described. Herein, the apparatus may be a wireless device (100 or 200) in FIGS. 2. 3, and 5.

For example, a wireless device may perform the methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be configured to control the transceiver 106 to receive, from a network, a configuration for a data traffic assistance information message. For example, the configuration may include a triggering condition for the data traffic assistance information message. The processor 102 may be configured to derive a predictive data traffic for a future time and/or a future location. Based on the predictive data traffic satisfying the triggering condition, the processor 102 may be configured to control the transceiver 106 to transmit the data traffic assistance information message including (i) information on the predictive data traffic and (ii) information on the future time and/or the future location.

For example, the information on the predictive data traffic may include information on service priority, delay tolerance, data rate, data volume, traffic type, time criticality, and/or packet size(s) of traffic in the wireless device.

According to some embodiments of the present disclosure, the processor 102 may be configured to derive a predictive future time and/or a predictive future location in which another predictive data traffic satisfies the triggering condition.

For example, the data traffic assistance information message includes (i) information on the predictive future time and/or the predictive future location and/or (ii) information on the other predictive data traffic.

For example, the triggering condition may include a condition which is satisfied based on that an amount of the predictive data traffic is equal to or greater than a threshold value.

For example, the triggering condition may include a condition which is satisfied based on that an amount of the predictive data traffic is less than a threshold value.

For example, the triggering condition may include a condition related to a time value at which the predictive data traffic is driven.

For example, the triggering condition may include a condition related to a location value on which the predictive data traffic is driven.

For example, the triggering condition may include a condition related to a data type of the predictive data traffic.

For example, the triggering condition may include a condition related to a latency of the predictive data traffic.

For example, the processor 102 may be configured to control the transceiver 106 to receive, from the network, a configuration related to a Machine Learning (ML) model to be used for deriving the predictive data traffic.

For example, the processor 102 may be configured to control the transceiver 106 to be in communication with at least one of a user equipment, a network, or an autonomous vehicle other than the wireless device.

Hereinafter, a processor for a wireless device for reporting data traffic based on prediction in a wireless communication system, according to some embodiments of the present disclosure, will be described.

The processor may be configured to control the wireless device to receive, from a network, a configuration for a data traffic assistance information message. For example, the configuration may include a triggering condition for the data traffic assistance information message. The processor may be configured to control the wireless device to derive a predictive data traffic for a future time and/or a future location. Based on the predictive data traffic satisfying the triggering condition, the processor may be configured to control the wireless device to transmit the data traffic assistance information message including (i) information on the predictive data traffic and (ii) information on the future time and/or the future location.

For example, the information on the predictive data traffic may include information on service priority, delay tolerance, data rate, data volume, traffic type, time criticality, and/or packet size(s) of traffic in the wireless device.

According to some embodiments of the present disclosure, the processor may be configured to control the wireless device to derive a predictive future time and/or a predictive future location in which another predictive data traffic satisfies the triggering condition.

For example, the data traffic assistance information message includes (i) information on the predictive future time and/or the predictive future location and/or (ii) information on the other predictive data traffic.

For example, the triggering condition may include a condition which is satisfied based on that an amount of the predictive data traffic is equal to or greater than a threshold value.

For example, the triggering condition may include a condition which is satisfied based on that an amount of the predictive data traffic is less than a threshold value.

For example, the triggering condition may include a condition related to a time value at which the predictive data traffic is driven.

For example, the triggering condition may include a condition related to a location value on which the predictive data traffic is driven.

For example, the triggering condition may include a condition related to a data type of the predictive data traffic.

For example, the triggering condition may include a condition related to a latency of the predictive data traffic.

For example, the processor may be configured to control the wireless device to receive, from the network, a configuration related to a Machine Learning (ML) model to be used for deriving the predictive data traffic.

For example, the processor may be configured to control the wireless device to be in communication with at least one of a user equipment, a network, or an autonomous vehicle other than the wireless device.

Hereinafter, a non-transitory computer-readable medium has stored thereon a plurality of instructions for reporting data traffic based on prediction in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory. EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-

readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored plurality of instructions may be executed by a processor of a wireless device.

The stored plurality of instructions may cause the wireless device to receive, from a network, a configuration for a data traffic assistance information message. For example, the configuration may include a triggering condition for the data traffic assistance information message. The stored plurality of instructions may cause the wireless device to derive a predictive data traffic for a future time and/or a future location. Based on the predictive data traffic satisfying the triggering condition, the stored plurality of instructions may cause the wireless device to transmit the data traffic assistance information message including (i) information on the predictive data traffic and (ii) information on the future time and/or the future location.

For example, the information on the predictive data traffic may include information on service priority, delay tolerance, data rate, data volume, traffic type, time criticality, and/or packet size(s) of traffic in the wireless device.

According to some embodiments of the present disclosure, the stored plurality of instructions may cause the wireless device to derive a predictive future time and/or a predictive future location in which another predictive data traffic satisfies the triggering condition.

For example, the data traffic assistance information message includes (i) information on the predictive future time and/or the predictive future location and/or (ii) information on the other predictive data traffic.

For example, the triggering condition may include a condition which is satisfied based on that an amount of the predictive data traffic is equal to or greater than a threshold value.

For example, the triggering condition may include a condition which is satisfied based on that an amount of the predictive data traffic is less than a threshold value.

For example, the triggering condition may include a condition related to a time value at which the predictive data traffic is driven.

For example, the triggering condition may include a condition related to a location value on which the predictive data traffic is driven.

For example, the triggering condition may include a condition related to a data type of the predictive data traffic.

For example, the triggering condition may include a condition related to a latency of the predictive data traffic.

For example, the stored plurality of instructions may cause the wireless device to receive, from the network, a configuration related to a Machine Learning (ML) model to be used for deriving the predictive data traffic.

According to some embodiments of the present disclosure, the stored plurality of instructions may cause the wireless device to be in communication with at least one of a user equipment, a network, or an autonomous vehicle other than the wireless device.

Hereinafter, a method performed by a base station (BS) for reporting data traffic based on prediction in a wireless communication system, according to some embodiments of the present disclosure, will be described.

The BS may provide, to a wireless device, a configuration for a data traffic assistance information message. For example, the configuration may include a triggering condition for the data traffic assistance information message.

The BS may receive, from the wireless device, the data traffic assistance information message including (i) information on a predictive data traffic and (ii) information on a future time and/or a future location. For example, the predictive data traffic may be derived by the wireless device based on the future time and/or the future location.

Hereinafter, a base station (BS) for reporting data traffic based on prediction in a wireless communication system, according to some embodiments of the present disclosure, will be described.

The BS may include a transceiver, a memory, and a processor operatively coupled to the transceiver and the memory.

The processor may be configured to control the transceiver to provide, to a wireless device, a configuration for a data traffic assistance information message. For example, the configuration may include a triggering condition for the data traffic assistance information message.

The processor may be configured to control the transceiver to receive, from the wireless device, the data traffic assistance information message including (i) information on a predictive data traffic and (ii) information on a future time and/or a future location. For example, the predictive data traffic may be derived by the wireless device based on the future time and/or the future location.

The present disclosure can have various advantageous effects.

According to some embodiments of the present disclosure, a wireless device could efficiently report data traffic based on prediction in a wireless communication system.

For example, based on the prediction information received from the UE, the network can carefully decide the desirable NES state considering expected UE's data traffic conditions or desirable DRX configuration parameters to balance between delay and UE power saving. The present disclosure allows the network to avoid incorrect/inefficient switch-off of network or wrong radio resource reservation for the future time/location or inefficient DRX parameters to be configured to the UE.

For example, the network can determine the start time/duration of deactivation/activation of the network energy saving state through predictive data traffic information. Therefore, UE/Network performance impact due to wrong-switch off can be prevented.

For example, as a wireless device informs the network of the predictive data traffic. the network can use resources efficiently.

According to some embodiments of the present disclosure, a wireless network system could provide an efficient solution for activating or deactivating network energy solution by receiving the predictive data traffic report.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method, comprising:
receiving, by a wireless device from a network, a configuration for a data traffic assistance information message,
wherein the configuration includes a triggering condition for the data traffic assistance information message;
deriving, by the wireless device, a predictive data traffic for a future time and/or a future location;
based on the predictive data traffic satisfying the triggering condition, transmitting, by the wireless device, the data traffic assistance information message including (i) information on the predictive data traffic and (ii) information on the future time and/or the future location.

2. The method of claim 1,
wherein the information on the predictive data traffic includes information on service priority, delay tolerance, data rate, data volume, traffic type, time criticality, and/or packet size(s) of traffic in the wireless device.

3. The method of claim 1, wherein the method further comprises,
deriving, by the wireless device, a predictive future time and/or a predictive future location in which another predictive data traffic satisfies the triggering condition.

4. The method of claim 3,
wherein the data traffic assistance information message includes (i) information on the predictive future time and/or the predictive future location and/or (ii) information on the other predictive data traffic.

5. The method of claim 1,
wherein the triggering condition includes a condition which is satisfied based on that an amount of the predictive data traffic is equal to or greater than a threshold value.

6. The method of claim 1,
wherein the triggering condition includes a condition which is satisfied based on that an amount of the predictive data traffic is less than a threshold value.

7. The method of claim 1,
wherein the triggering condition includes a condition related to a time value at which the predictive data traffic is driven.

8. The method of claim 1,
wherein the triggering condition includes a condition related to a location value on which the predictive data traffic is driven.

9. The method of claim 1,
wherein the triggering condition includes a condition related to a data type of the predictive data traffic.

10. The method of claim 1,
wherein the triggering condition includes a condition related to a latency of the predictive data traffic.

11. The method of claim 1, wherein the method further comprises,
receiving, by the wireless device from the network, a configuration related to a Machine Learning (ML) model to be used for deriving the predictive data traffic.

12. The method of claim 1,
wherein the wireless device is in communication with at least one of a user equipment, a network, or an autonomous vehicle other than the wireless device.

13. A wireless device in a wireless communication system comprising:
a transceiver;
a memory; and
at least one processor operatively coupled to the transceiver and the memory, and adapted to:
control the transceiver to receive, from a network, a configuration for a data traffic assistance information message,
wherein the configuration includes a triggering condition for the data traffic assistance information message;
derive a predictive data traffic for a future time and/or a future location;
based on the predictive data traffic satisfying the triggering condition, control the transceiver to transmit the data traffic assistance information message including (i) information on the predictive data traffic and (ii) information on the future time and/or the future location.

14. The wireless device of claim 13,
wherein the information on the predictive data traffic includes information on service priority, delay tolerance, data rate, data volume, traffic type, time criticality, and/or packet size(s) of traffic in the wireless device.

15. The wireless device of claim 13, wherein the at least one processor is further adapted to:
derive a predictive future time and/or a predictive future location in which another predictive data traffic satisfies the triggering condition.

16. The wireless device of claim 15,
wherein the data traffic assistance information message includes (i) information on the predictive future time and/or the predictive future location and/or (ii) information on the other predictive data traffic.

17. The wireless device of claim 13,
wherein the triggering condition includes a condition which is satisfied based on that an amount of the predictive data traffic is equal to or greater than a threshold value.

18. The wireless device of claim 13,
wherein the triggering condition includes a condition which is satisfied based on that an amount of the predictive data traffic is less than a threshold value.

19. The wireless device of claim 13,
wherein the triggering condition includes a condition related to a time value at which the predictive data traffic is driven.

20-26. (canceled)

27. A method, comprising,
providing, by a base station to a wireless device, a configuration for a data traffic assistance information message,
wherein the configuration includes a triggering condition for the data traffic assistance information message;
receiving, by the base station from the wireless device, the data traffic assistance information message including (i) information on a predictive data traffic and (ii) information on a future time and/or a future location,
wherein the predictive data traffic is derived by the wireless device based on the future time and/or the future location.

28. (canceled)
